(19) United States
(12) Patent Application Publication
(10) Pub. No.: US 2015/0058084 A1
(43) Pub. Date: Feb. 26, 2015

(54) SERVICE CONTENT PROPOSAL SYSTEM, SERVICE CONTENT PROPOSAL DEVICE, SERVICE CONTENT PROPOSAL METHOD, AND RECORDING MEDIUM

(71) Applicant: NEC CORPORATON, Tokyo (JP)

(72) Inventors: Satoko Itaya, Tokyo (JP); Rie Tanaka, Tokyo (JP); Taku Konishi, Tokyo (JP); Shinichi Doi, Tokyo (JP)

(73) Assignee: NEC CORPORATION, Tokyo (JP)

(21) Appl. No.: 14/389,325

(22) PCT Filed: Mar. 28, 2013
(86) PCT No.: PCT/JP2013/059333

§ 371 Date: Sep. 29, 2014

(30) Foreign Application Priority Data
Mar. 29, 2012 (JP) 2012-076901

(51) Int. Cl. G06Q 30/02

(52) U.S. Cl. CPC G06Q 30/0203
USPC 705/7.32

(57) ABSTRACT

A candidate determination unit (13) calculates a prescribed parameter value on the basis of the statistical data (If) of service provided up to the present time, and on the basis of provider selection criteria and user selection criteria, in relation a service candidate stored by a storage unit (12), and determines a service candidate proposed to a provider on the basis thereof. The candidate determination unit (13) generates proposal information (Ib) indicating a service candidate. A selection criteria adjustment unit (16) adjusts the provider selection criteria on the basis of provider selection information (Ic) received by a provider selection information receiver (15) and service candidate information (Ie) indicating a value of the prescribed parameter of the determined service candidate. Also, the selection criteria adjustment unit (16) adjusts the user selection criteria on the basis of action information (Ia).

### TECHNICAL FIELD

The present disclosure relates to a service content proposal system, service content proposal device, service content proposal method, and non-transitory recording medium for proposing to a provider providing services to one or multiple users the contents of the services the provider provides.

### BACKGROUND ART

Generally, a service provider determines the service contents based on the results of needs surveys using questionnaires or the actual use of provided services, or reviews the service contents for providing better services.

Techniques for facilitating the service contents review have been proposed. For example, Patent Literature 1 discloses a device acquiring the answers to questionnaires and/or the actual use of services as service user satisfaction level information and statistically processing the acquired satisfaction level information to create statistical satisfaction level data. A service provider reviews the providing service contents referring the statistical satisfaction level data,

### CITATION LIST

### Patent Literature

Patent Literature 1: Unexamined Japanese Patent Application Kokai Publication No. 2003-281343.

### SUMMARY OF INVENTION

### Technical Problem

The device disclosed in the Patent Literature 1 simply provides the service provider with the statistical data presenting the satisfactory level of the customers on the provided services. Therefore, the service provider itself has to review the service contents to provide based on the statistical data.

Furthermore, the device disclosed in the Patent Literature 1 obtains the statistical data through the process of distributing, collecting, counting, and analyzing questionnaires. Therefore, a problem is that it takes time before delivering the statistical data to the service provider.

The present disclosure is made with the view of the above situation and an objective of the present disclosure is to provide a service content proposal system, service content proposal device, service content proposal method, and non-transitory recording medium that can propose specific service contents to a service provider.

Furthermore, another objective of the present disclosure is to provide a service content proposal system, service content proposal device, service content proposal method, and non-transitory recording medium that can propose service contents to a service provider efficiently.

### Solution to Problem

The service content proposal system according to a first exemplary aspect of the present disclosure is a service content proposal system proposing to a provider candidates for a service the provider provides to a user, comprising a user device, a provider device, and a service content proposal device, wherein

the user device comprises:

an acquirer that acquires user information including information regarding a service selected by the user and information regarding the user's action of using the selected service,

the provider device comprises:

a selector that receives selection from the candidates, and

the service content proposal device comprises:

a user information receiver that receives the user information from the user device;

a candidates designator that designates the candidates of which the values of given parameters satisfy given conditions based on statistical data of the service including the user information and provider selection criteria and user selection criteria including the parameters, and creating proposal information presenting the designated candidates;

a transmitter that transmits the proposal information to the provider device;

a provider selection information receiver that receives from the provider device provider selection information presenting the service selected by the provider;

a provider selection criteria adjuster that adjusts the provider selection criteria based on the provider selection information and the values of the parameters; and

a user selection criteria adjuster that adjusts the user selection criteria based on the user information.

The service content proposal device according to a second exemplary aspect of the present disclosure is a service content proposal device connected to a user device and a provider device and proposing to a provider candidates for a service the provider provides to a user, comprising:

a receiver that receives from the user device user information including information regarding a service selected by the user and information regarding the user's action of using the selected service;

a candidates designator that designates the service candidates of which the values of given parameters satisfy given conditions based on statistical data of the service including the user information and each of provider selection criteria and user selection criteria including the parameters, and creating proposal information presenting the designated service candidates;

a transmitter that transmits the proposal information to the provider device;

a provider selection information receiver that receives from the provider device provider selection information presenting the service selected by the provider;

a provider selection criteria adjuster that adjusts the provider selection criteria based on the provider selection information and the values of the parameters; and

a user selection criteria adjuster that adjusts the user selection criteria based on the user information.

The service content proposal method according to a third exemplary aspect of the present disclosure comprises:

an acquisition step of acquiring user information including information regarding a service selected by a user and information regarding the user's action of using the selected service,

a user information reception step of receiving the user information from a user device;

a candidates designation step of designating the service candidates of which the values of given parameters satisfy given conditions based on statistical data of the service including the user information and each of provider selection criteria and user selection criteria including the parameters, and creating proposal information presenting the designated candidates;

a transmission step of transmitting the proposal information to a provider device;

an output step of outputting the proposal information;

a selection step of receiving selection of the service by the provider based on the proposal information;

a provider selection information reception step of receiving from the provider device provider selection information presenting the service candidate selected by the provider;

a provider selection criteria adjustment step of adjusting the provider selection criteria based on the provider selection information and the values of the parameters; and

a user selection criteria adjustment step of adjusting the user selection criteria based on the user information.

The computer-readable non-transitory recording medium according to a fourth exemplary aspect of the present disclosure records programs that allow a computer to function as:

a user information receiver that receives from a user device user information including information regarding a service selected by the user and information regarding the user's action of using the selected service;

a candidates designator that designates the service candidates of which the values of given parameters satisfy given conditions based on statistical data of the service including the user information and each of provider selection criteria, and user selection criteria including the parameters, and creating proposal information presenting the designated service candidates;

a provider selection information receiver that receives from a provider device provider selection information presenting the service selected by the provider;

a provider selection criteria adjuster that adjusts the provider selection criteria based on the provider selection information and the values of the parameters; and

a user selection criteria adjuster that adjusts the user selection criteria based on the user information.

### Advantageous Effects of Invention

According to the present invention, it is possible to propose service candidates of which the service contents satisfy the service users to a service provider, and suppress cost increase due to continuing provision of services of which the service contents are unsatisfactory.

### BRIEF DESCRIPTION OF DRAWINGS

FIG. 1 is a block diagram showing an exemplary configuration of the service content proposal system according to Embodiment 1 of the present disclosure;

FIGS. 2A and 2B are charts for explaining exemplary actual use of the current service;

FIGS. 3A and 313 are charts for explaining exemplary prospective use of a service candidate;

FIGS. 4A and 4B are charts for explaining exemplary prospective use of a service candidate;

FIG. 5 is a chart presenting the values of the parameters of the service candidates including the current service according to Embodiment 1;

FIG. 6 is a chart for explaining the calculation of the selection criteria value based on the provider selection criteria;

FIG. 7 is a chart for explaining the calculation of the selection criteria value based on the user selection criteria;

FIG. 8 is a chart showing an example of the provider selection information;

FIG. 9 is a flowchart showing an example of the service content proposal operation according to Embodiment 1;

FIGS. 10A and 10B are flowcharts showing an example of the operation to adjust the provider selection criteria and user selection criteria according to Embodiment 1;

FIG. 11 is a graphical representation for explaining an example of the other exemplary service candidates designation method according to Embodiment 1;

FIG. 12 is a block diagram showing an exemplary configuration of the service content proposal system according to Embodiment 2 of the present disclosure;

FIG. 13 is a flowchart showing an example of the service content proposal operation according to Embodiment 2;

FIGS. 14A and 14B are flowcharts showing an example of the operation to adjust the provider selection criteria and user selection criteria according to Embodiment 2;

FIG. 15 is a chart presenting the values of the parameters of the user service candidates including the current service according to Embodiment 2;

FIG. 16 is a chart showing an example of the user selection information;

FIGS. 17A and 17B are charts for explaining the calculation of the selection criteria value based on the user selection criteria of each user class;

FIG. 18 is a graphical representation for explaining an example of the second service candidates designation method according to Embodiment 2; and

FIG. 19 is a block diagram showing an exemplary hardware configuration of the service content proposal device according to the embodiments.

### DESCRIPTION OF EMBODIMENTS

The present disclosure proposes service contents to a provider who successively provides services to multiple users.

Embodiments of the present disclosure will be described in detail hereafter with reference to the drawings. In the figures, the same or corresponding components are referred to by the same reference numbers.

### Embodiment 1

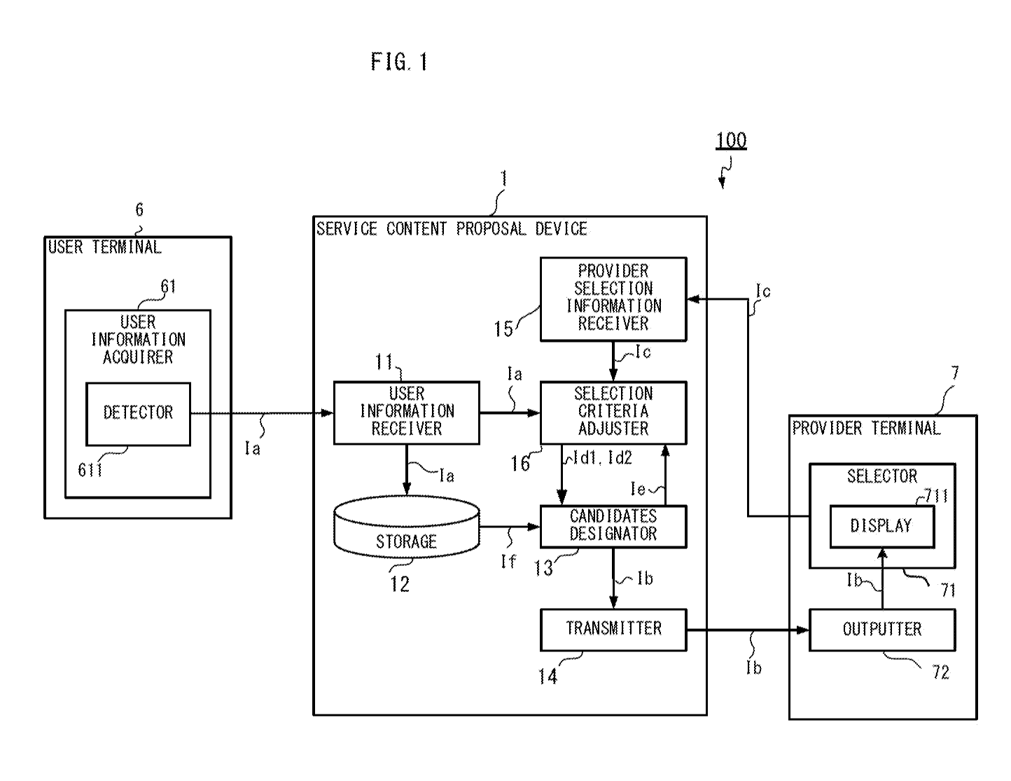

FIG. 1 is a block diagram showing an exemplary configuration of the service content proposal system according to Embodiment 1 of the present disclosure. A service content proposal system 100 of Embodiment 1 comprises a service content proposal device 1, a user terminal (device) 6, and a provider terminal (device) 7. The user terminal 6, provider terminal 7, and service content proposal device 1 are mutually communicable via a network. Furthermore, one user terminal 6 and one provider terminal 7 are shown for easy understanding of the description; however, multiple user terminals 6 and multiple provider terminals 7 can be connected to the network. In this embodiment, one provider provides services. The provider terminal 7 can be a part of the service content proposal device 1 or an auxiliary device.

The user terminal 6 comprises a user information acquirer 61 acquiring user information including information regarding a service selected by the user and information regarding the action of the user using the selected service. In this embodiment, the user information acquirer 61 comprises a detector 611 detecting the user information.

In the case of detecting, for example, use of a store or a means of transportation by the user, the detector 611 detects it by receiving information presenting use of the user's credit card, electronic money, transportation IC card, or the like from a card payment system or the like (not shown). On the other hand, in the case of detecting a waiting line or the like from the location of the user using a RF (radio frequency) tag, the detector 611 detects change in the location of the user using a RF tag reader. The user terminal 6 sends to the service content proposal device 1 action information Ia presenting a service selected by the user and detected by the detector 611 and the action of the user having used the selected service. In other words, in this embodiment, the user information is the action information Ia.

Alternatively, the location of the user can be detected by using a GPS (global positioning system) or calculating the location based on the electric field intensity received at the mobile communication base station. Furthermore, it is possible to install a camera at the site where the service is provided and acquire information presenting the location or face expression of people using image recognition techniques.

The provider terminal 7 comprises a selector 71 receiving selection of a service by the service provider and an outputter 72 outputting information received from the service content proposal device 1. The outputter 72 receives proposal information Ib presenting one or multiple services as the service candidates the service content proposal device 1 proposes to the provider, and displays as an image or outputs as sound the proposal information Ib. The service provider selects via the selector 71 one service to provide to the user from among the service candidates presented by the proposal information Ib output by the outputter 72. The selector 71 sends provider selection information ic resenting the one service selected by the provider to the service content proposal device 1.

The service content proposal device 1 comprises a user information receiver 11, a storage 12, a candidate designator 13, a transmitter 14, a provider selection information receiver 15, and a selection criteria adjuster 16.

The user information receiver 11 receives the action information Ia from the user terminal 6. The user information receiver 11 sends the action information Ia received within a given time period to the storage 12 and selection criteria adjuster 16 at given time intervals.

The storage 12 pre-stores one or multiple services as service candidates the service provider can provide. The storage 12 further stores information on the service the provider currently provides to the user (the current service, hereafter). The information on the current service includes the latest action information Ia within a given time period that is received from the user information receiver 11. The storage 12 further stores statistical data If regarding the contents of services provided up to the present, conditions, number of times of provision, provision time windows, provision fees, and the like, which are accumulated information on the current service.

The service candidates stored in the storage 12 can be pre-entered into the storage 12 by the provider or automatically created and stored in the storage 12 by the service content proposal device 1 from the contents of services provided by the service provider in the past, resource restrictions, service conditions, and the like.

The candidates designator 13 receives from the selection criteria adjuster 16 selection criteria information Id1 presenting provider selection criteria and selection criteria information Id2 presenting user selection criteria, including given parameters. The provider selection criteria and user selection criteria are criteria for service selection by the provider and the user, respectively, that the selection criteria adjuster 16 presumes. For example, the provider selection criteria and user selection criteria are each expressed by parameters such as a service fee and service waiting time, calculation formulae normalizing the values of the parameters, and evaluation coefficients weighting the parameters. Alternatively, the provider selection criteria and user selection criteria are each expressed by a formula comprising variables presenting the normalized values of parameters such as a service fee and service waiting time and a constant. The candidates designator 13 receives from the storage 12 the statistical data If regarding the services provided up to the present and stored in the storage 12 for the service candidates stored in the storage 12.

The candidates designator 13 calculates the values of given parameters based on the statistical data If from the storage 12 and the provider selection criteria and user selection criteria from the selection criteria adjuster 16. The candidates designator 13 designates one or multiple services of which the values of given parameters satisfy given conditions from among the service candidates stored in the storage 12 as service candidates to propose to the provider.

The candidates designator 13 creates proposal information Ib presenting the designated service candidates and sends the proposal information Ib to the transmitter 14. Furthermore, the candidates designator 13 sends service candidates information le presenting the values of given parameters of the designated service candidates to the selection criteria adjuster 16.

When the provider selection criteria, and user selection criteria are each expressed by parameters such as a service fee and service waiting time, calculation formulae normalizing the values of the parameters, and evaluation coefficients weighting the parameters, the candidates designator 13 calculates selection criteria values based on the statistical data if from the storage 12 and the provider selection criteria and user selection criteria, and designates the services of which the total of the selection criteria values is equal to or higher than the total of the selection criteria values of the current service as service candidates to propose to the provider.

When the provider selection criteria and user selection criteria are each expressed by a formula comprising variables presenting the normalized values of parameters such as a service fee and service waiting time and a constant, the candidates designator 13 calculates a provider acceptable range and a user acceptable range based on the statistical data If from the storage 12 and the provider selection criteria and user selection criteria, respectively, and designates the service candidates that are plotted in the region contained in both the provider acceptable range and user acceptable range as service candidates to propose to the provider.

The transmitter 14 sends the proposal information Ib received from the candidates designator 13 to the provider terminal 7.

The provider selection information receiver 15 receives the provider selection information Ic from the provider terminal 7. The provider selection information receiver 15 sends the received provider selection information Ic to the selection criteria adjuster 16.

The selection criteria adjuster 16 stores the provider selection criteria and user selection criteria and sends the selection criteria information Id1 and Id2 presenting the provider selection criteria and user selection criteria, respectively, to the candidates designator 13. Furthermore, the selection criteria adjuster 16 adjusts the provider selection criteria based on the provider selection information Ic received from the provider selection information receiver 15 and the service candidates information Ie received from the candidates designator 13. The selection criteria adjuster 16 further adjusts the user selection criteria based on the action information Ia received from the user information receiver 11.

When the provider selection criteria and user selection criteria, are each expressed by parameters such as a service fee and service waiting time, calculation formulae normalizing the values of the parameters, and evaluation coefficients weighting the parameters, the selection criteria adjuster 16 adjusts the provider selection criteria and user selection criteria by changing the corresponding evaluation coefficients.

When the provider selection criteria and user selection criteria are each expressed by a formula comprising variables presenting the normalized values of parameters such as a service fee and service waiting time and a constant, the selection criteria adjuster 16 adjusts the provider selection criteria and user selection criteria by changing the coefficients of the corresponding variables and/or the constant.

A case in which this embodiment is applied to a bus distribution system will be described hereafter. The bus operation service provider provides bus operation services to general bus users. The service proposal device collects information presenting the bus users' action of using a service, creates a bus operation schedule to propose for improving the current bus operation service, and proposes the schedule to the bus operation service provider. Then, the service proposal device adjusts the provider selection criteria of the bus operation service provider and the user selection criteria of the bus users separately.

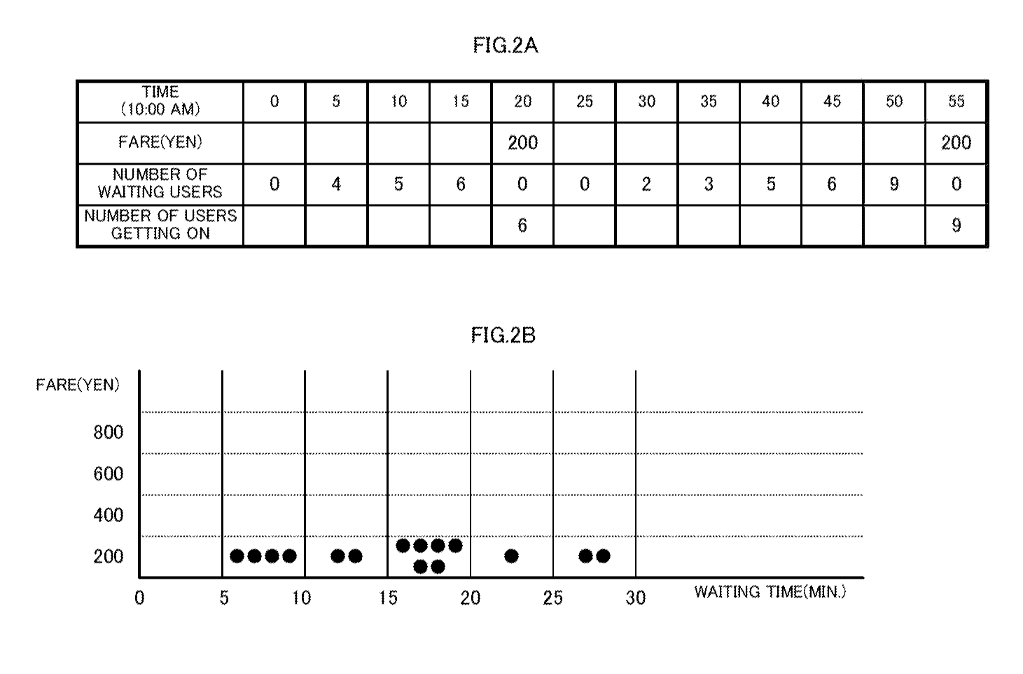

FIGS. 2A and 2B are charts for explaining exemplary actual use of the current service. FIG. 2A presents the bus fares, number of waiting people in each time window, and number of people getting on the bus at a bus stop on a bus operation schedule for one hour from, for example, 10 AM. According to the current bus operation schedule, two buses leave at 10:20 and 10:55, respectively, within one hour. The fares of these buses are both 200 yen. The candidates designator 13 calculates the actual use as shown in FIG. 2A based on information presenting the current service such as the bus operation schedule and fares of the current service stored in the storage 12 and the latest action information Ia within a given time period. The given time period is, for example, one hour.

According to the actual use in FIG. 2A, there is no user waiting at 10:00 AM. Five minutes later or at 10:05 AM, there are four users waiting. Then, another five minutes later or at 10:10 AM, there are five users waiting. Then, five more minutes later or at 10:15 AM, there are six users waiting. The number of users increased one by one every five minutes in 15 minutes from 10:05 AM. When a bus arrives at 10:20 AM, the six waiting users get on the bus and than there is no waiting user. Subsequently, there is no user waiting at 10:25 AM. There are two users waiting at 10:30 AM. There are three users waiting at 10:35 AM. There are five users waiting at 10:40 AM. There are six users waiting at 10:45 AM. There are nine users waiting at 10:50 AM. Then, when a bus arrives at 10:55 AM, the nine waiting users get on the bus and then there is no waiting user.

FIG. 2B shows the distribution of the actual use in FIG. 2A with the fare (yen) as the ordinate and the waiting time (min.) as the abscissa in which the numbers of users are presented by the numbers of Hack filled circles. The bus fares of the two buses are both 200 yen. Therefore, all users belong to the bus fare zone of 200 yen. There is no user who has no waiting time (zero-min, waiting time). A total of four users, one who started waiting between 10:10 and 10:15 AM and three who started waiting between 10:45 and 10:50 AM, waited for 0-5 min. For the similar reasons, two users waited for 5-10 min., six users waited for 10-15 min., one user waited for 15-20 min., and two users waited for 20-25 min. No user waited for more than 30 min.

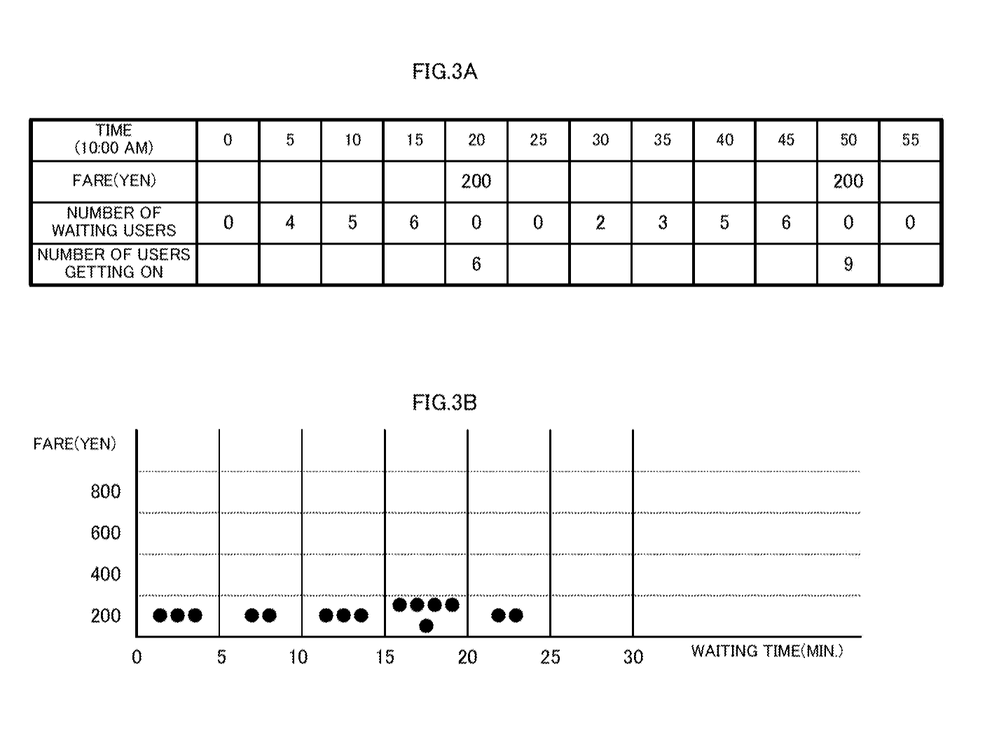

FIGS. 3A and 3B are charts for explaining exemplary prospective use of a service candidate. The service candidate in FIGS. 3A and 3B is an exemplary service candidate proposed by the service content proposal device 1 to the provider providing the current service in FIGS. 2A and 2B. According to the bus operation schedule in FIG. 3A, two buses leave at 10:20 and 10:50, respectively, within one hour from, for example, 10:00 AM. The bus fares of these buses are both 200 yen. The candidates designator 13 calculates the prospective use as shown in FIG. 3A based on the bus operation schedule and fares of this service candidate stored in the storage 12 and the statistical data If of the services provided up to the present including information on the current service.

From 10:00 to 10:45 AM, no change is made from the current service in FIGS. 2A and 2B and therefore the prospective use in FIG. 3A is the same as the actual use in FIG. 2A. However, when a bus arrives at 10:50 AM, a total of nine people, six who were waiting and three who arrived at the bus stop between 10:45 and 10:50 AM, get on the bus and then there is no user waiting. There is no user waiting from 10:50 to 10:55 AM.

FIG. 3B shows the distribution of the prospective use in FIG. 3A with the fare (yen) as the ordinate and the waiting time (min.) as the abscissa in which the numbers of users are presented by the numbers of black filled circles. The bus fares of the two buses are both 200 yen. Therefore, all users belong to the bus fare zone of 200 yen. Three users who arrive at the bus stop between 10:45 and 10:50 AM wait for 0 to less than 5 min. Two users, one who arrives at the bus stop between 10:10 and 10:15 AM and one who arrives at the bus stop between 10:40 and 10:45 AM, wait for 5 to less than 110 min. Similarly, three users wait for 10 to less than 15 min. Five users wait for 15 to less than 20 min. Two users wait for 20 to less than 25 min. No user waits for 25 to less than 30 min. No user waits for more than 30 min.

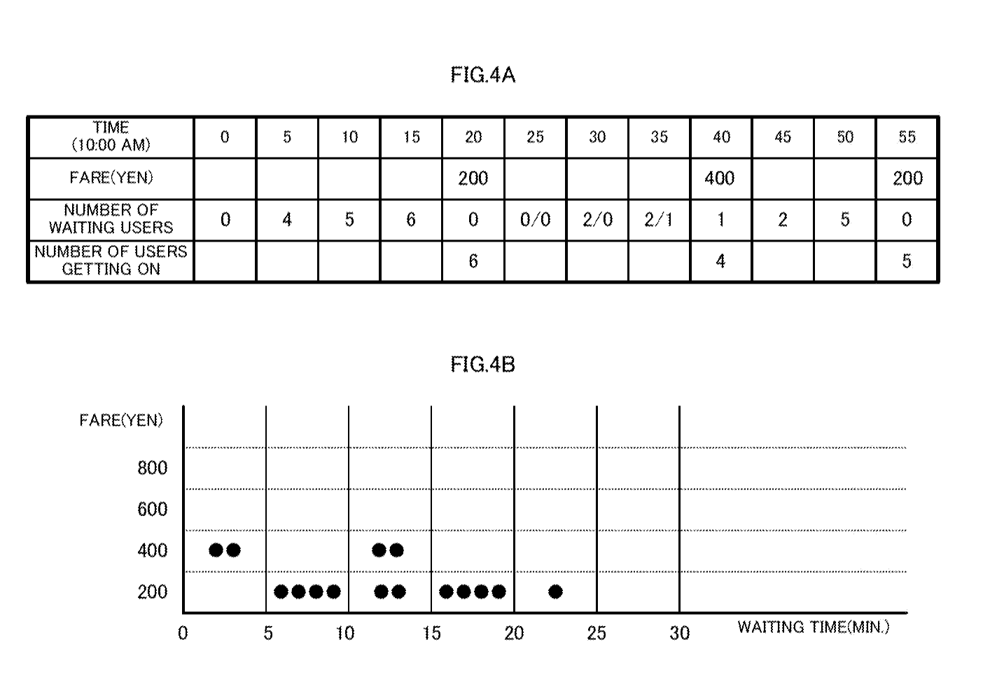

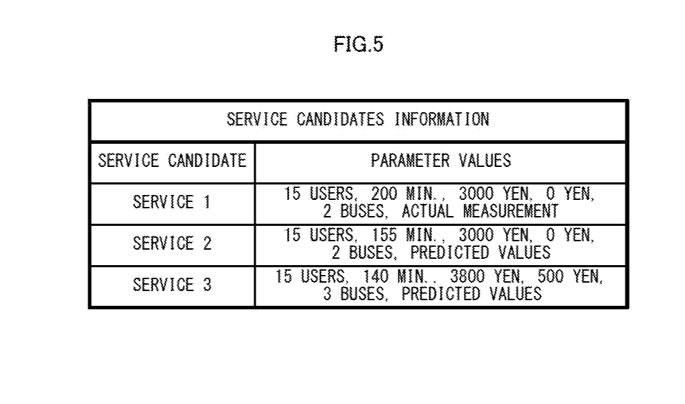

FIGS. 4A and 4B are charts for explaining exemplary prospective use of a service candidate. The service candidate in FIGS. 4A and 4B is an exemplary service candidate proposed by the service content proposal device 1 to the provider providing the current service in FIGS. 2A and 2B. According to the bus operation schedule in FIG. 4A, three buses leave at 10:20, 10:40, and 10:55, respectively, within one hour from, for example, 10:00 AM. The bus fares of the buses departing at 10:20 and 10:50 are both 200 yen and the bus fare of the bus departing at 10:40 is 400 yen. The candidates designator 13 calculates the prospective use as shown in FIG. 4A based on the bus operation schedule and fares of this service candidate stored in the storage 12 and the statistical data If of the services provided up to the present including information on the current service.

From 10:00 to 10:20 AM, no change is made from the current service in FIGS. 2A and 2B and therefore the prospective use in FIG. 4A is the same as the actual use in FIG. 2A. The number of users who are waiting from between 10:25 to 10:35 AM is expressed by the number of users waiting for the bus departing at 10:40/the number of users waiting for the bus departing at 10:55) because they may pass on the bus departing at 10:40 AM, of which the fare is higher, and take the bus departing at 10:55 AM.

No user is waiting at 10:25 AM. Two users are waiting at 0:30 AM. Those two are presumed to be waiting for the bus departing at 10:40 AM. Three users are waiting at 10:35 AM. Among those three users, two are presumed to be waiting for the bus departing at 10:40 AM and one is presumed to be waiting for the bus departing at 1.0:55 AM. When a bus arrives at 10:40, the two who are waiting for the bus departing at 10:40 AM and two who arrive at the bus stop between 10:35 and 10:40 AM get on the bus and one user remains waiting. Two users are waiting at 10:45 AM. Five users are waiting at 10:50 AM. When a bus arrives at 10:55 AM, the five waiting people get on the bus and then there is no user waiting.

FIG. 4B shows the distribution of the prospective use in FIG. 4A with the fare (yen) as the ordinate and the waiting time (min.) as the abscissa in which the numbers of users are presented by the numbers of black filled circles. The bus fare for the users who get on the bus departing at 10:40 AM is 400 yen. The bus fare for the users who get on the other two buses is 200 yen. Therefore, the users are distributed in the bus fare zones of 200 yen and 400 yen. Two users wait for 0 to less than 5 min. and their fare is 400 yen. Four users wait for 5 to less than 10 min. and their fare is 200 yen. Four users wait for 10 to less than 15 min, and the fare is 400 yen for two of them and 200 yen for the other two. Four users wait for 15 to less than 20 min, and their fare is 200 yen. One user waits for 20 to less than 25 min. and his fare is 200 yen. No user waits for 25 to less than 30 min. No user waits for more than 30 min.

Incidentally, if the number of users gating on the bus departing at 10:40 AM is unpredictable in the prospective use of the service candidate shown in FIGS. 4A and 413, a range from 1 to 5 can be used since there are five users at the bus stop at 10:40 AM.

The candidates designator 13 calculates the values of parameters included in each of the provider selection criteria and user selection criteria in regard to the actual use of the current service and the prospective uses of the service candidates.

In this embodiment, the provider selection criteria and user selection criteria each include six parameters, the “number of users” presenting the total number of users in a target time period, “waiting time” presenting the total waiting time in the target time period, “fare” presenting the total fare in the target time period, “additional cost” presenting additional cost in the target time period that is required upon change from the current service, “number of buses” presenting the number of buses necessary for realizing the service, and “reliability” indicating actual measurement data or predicted data.

FIG. 5 is a chart showing the service candidates information le presenting the values of the parameters of the service candidates including the current service according to Embodiment 1. SERVICE 1 is the current service shown in FIGS. 2A and 213, SERVICE 2 is the service candidate shown in FIGS. 3A and 3B, and SERVICE 3 is the service candidate shown in FIGS. 4A and 4B. The candidates designator 13 calculates the values of the six parameters (the number of users, waiting time, fare, additional cost, number of buses, and reliability) of SERVICES 1 to 3.

The values of the parameters of SERVICE 1 are (15 users, 200 min., 3000 yen, 0 yen, 2 buses, and actual measurements). The values of the parameters of SERVICE 2 are (15 users, 155 min., 3000 yen, 0 yen, 2 buses, and predicted values). The values of the parameters of SERVICE 3 are (15 users, 140 min., 3800 yen, 500 yen, 3 buses, and predicted values). Here, if a range from 1 to 5 is used as the number of users getting on the bus departing at 10:40 AM in SERVICE 3, the values of the parameters of SERVICE 3 are (15 users, 125 min. to 200 min., 3000 yen to 4000 yen, 500 yen, 3 buses, and predicted values).

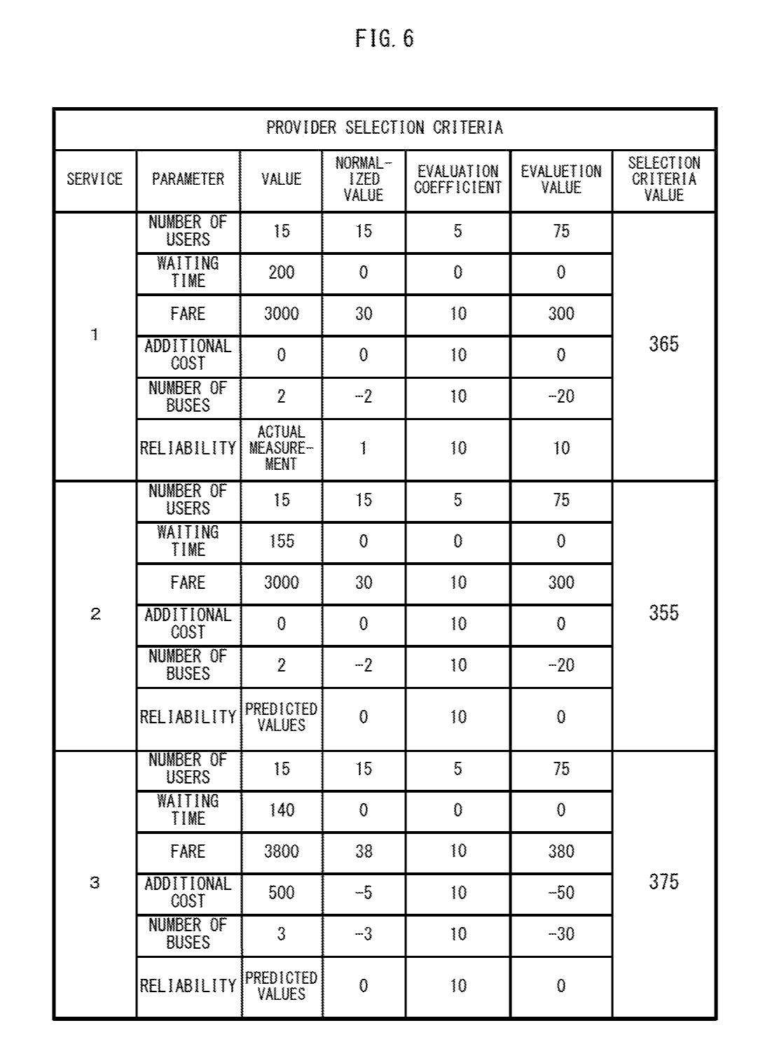

FIG. 6 is a chart for explaining the calculation of the selection criteria value based on the provider selection criteria. The provider selection criteria are expressed by the six parameters, calculation formulae normalizing the values of the parameters, and evaluation coefficients weighting the parameters. The calculation formulae normalizing the values of the parameters are preset. FIG. 6 shows exemplary selection criteria values of SERVICES 1 to 3 according to the provider selection criteria.

Here, the calculation formulae normalizing the values of the parameters will be described on the assumption that the parameters each have a value P. The calculation formula normalizing the value of a parameter multiplies the value by a positive value if the parameter is advantageous for the provider and multiplies the value by a negative value if the parameter is disadvantageous for the provider. In the case of FIG. 6, the calculation formula normalizing the value (users) of “the number of users” is (P×1); the calculation formula normalizing the value (min.) of “the waiting time” is (P×0); the calculation formula normalizing the value (yen) of “the fare” is (P×0.01); the calculation formula normalizing the value (yen) of “the additional cost” is (P x−0.01); the calculation formula normalizing the value of “the number of buses” is (P x−1); and the calculation formula normalizing the value of “the reliability” is (1 for actual measurements, 0 for predicted values). Here, “the waiting time” is assumed to be neither advantageous nor disadvantage for the provider and therefore multiplied by 0.

As shown in FIG. 6, the evaluation coefficient of “the number of users” is 5; the evaluation coefficient of “the waiting time” is 0; the evaluation coefficient of “the fare” is 10; the evaluation coefficient of “the additional cost” is 10; the evaluation coefficient of “the number of buses” is 10; and the evaluation coefficient of “the reliability” is 10. Here, it is possible to regard both “the additional cost” and “the number of buses” as resource consumption and combine one with the other and increase the value of the evaluation coefficient,

The evaluation values (“normalized value”×“evaluation coefficient”) of the parameters of SERVICE 1 calculated based on the above selection criteria are as follows: the evaluation value of “the number of users” is 75 (“15”×“5”); the evaluation value of “the waiting time” is 0 (“0”×“0”); the evaluation value of “the fare” is 300 (“30”×“10”); the evaluation value of “the additional cost” is 0 (“0”×“10”); the evaluation value of “the number of buses” is −20 (“−2”×“10”); and the evaluation value of “the reliability” is 10 (“1”×“10”).

The selection criteria value is the total of the evaluation values of the parameters. Then, the selection criteria value of SERVICE 1 according to the provider selection criteria is 75+0+300+0−20+10=365. Similarly calculated, the selection criteria value of SERVICE 2 is 355 and the selection criteria value of SERVICE 3 is 375 according to the provider selection criteria.

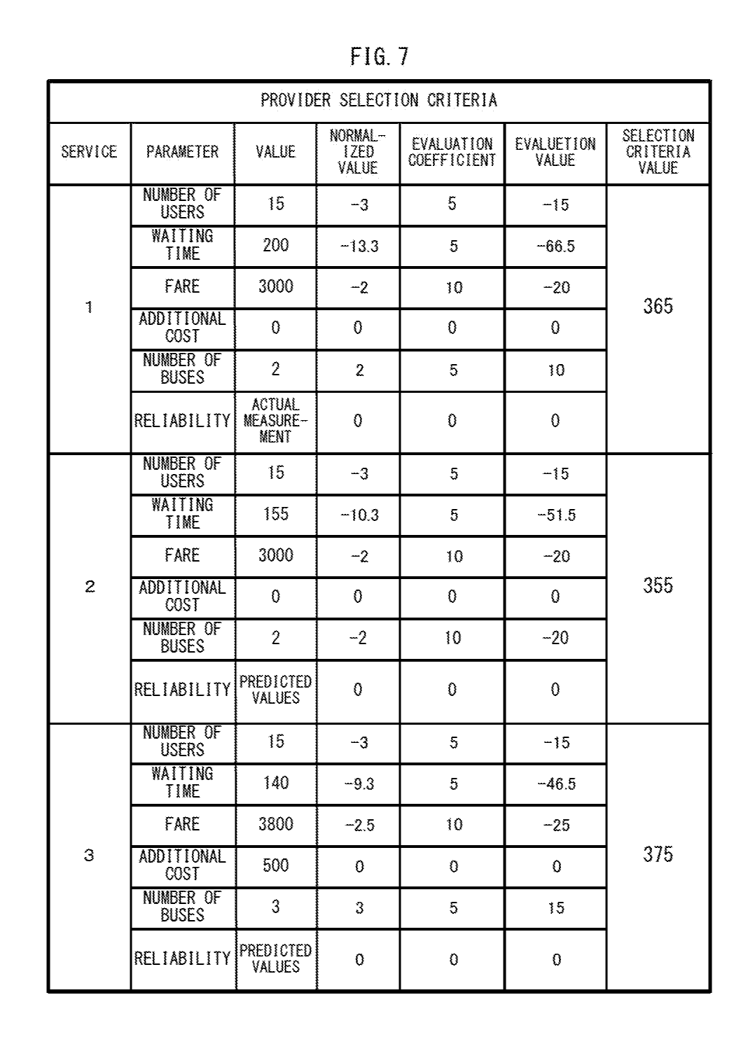

FIG. 7 is a chart for explaining the calculation of the selection criteria value based on the user selection criteria. The user selection criteria are, similarly to the provider selection criteria, expressed by six parameter, calculation formulae normalizing the values of the parameters, and evaluation coefficients weighting the parameters. FIG. 7 shows exemplary selection criteria values of SERVICES 1 to 3 according to the user selection criteria.

Here, the calculation formulae normalizing the values of the parameters will be described on the assumption that the parameters each have a value P. The calculation formula normalizing the value of a parameter multiplies the value by a positive value if the parameter is advantageous for the user and multiplies the value by a negative value if the parameter is disadvantageous for the user. In the case of FIG. 7, the calculation formula normalizing the value of “the number of users” is (P×−0.2); the calculation formula normalizing the value (min.) of “the waiting time” is (P×−1/the number of users); the calculation formula normalizing the value (yen) of “the fare” is (P×0.01/the number of users); the calculation formula normalizing the value (yen) of “the additional cost” is (P×0); the calculation formula normalizing the value of “the number of buses” is (P×1); and the calculation formula normalizing the value of “the reliability” is (0 for both actual measurements and predicted values). Here, “the additional cost” and “reliability” are assumed to be neither advantageous nor disadvantage for the user and therefore multiplied by 0.

As shown in FIG. 7, the evaluation coefficient of “the number of users” is 5; the evaluation coefficient of “the waiting time” is 0; the evaluation coefficient of “the fare” is 10; the evaluation coefficient of “the additional cost” is 0; the evaluation coefficient of “the number of buses” is 5; and the evaluation coefficient of “the reliability” is 0. The evaluation values of the parameters of SERVICE 1 calculated based on the above selection criteria are as follows: the evaluation value of “the number of users” is −15; the evaluation value of “the waiting time” is −66.5; the evaluation value of “the fare” is −20; the evaluation value of “the additional cost” is 0; the evaluation value of “the number of buses” is 10; and the evaluation value of “the reliability” is 0. Here, the evaluation values are rounded to the nearest tenth. The selection criteria value is the total of the evaluation values of the parameters. Then, the selection criteria value of SERVICE 1 according to the user selection criteria is −15−66.5−20+0+10=−91.5. Similarly calculated, the selection criteria value of SERVICE 2 is −76.5 and the selection criteria value of SERVICE 3 is −71.5 according to the user selection criteria.

The user selection criteria values of SERVICES 2 and 3 are equal to or higher than the user selection criteria value of the current SERVICE 1. Furthermore, the provider selection criteria value of SERVICE 3 is equal to or higher than the provider selection criteria value of the current SERVICE 1.

The candidates designator 13 calculates the selection criteria value according to the provider selection criteria, and the selection criteria value according to the user selection criteria, for the current SERVICE 1 and the service candidates stored in storage 12 as described above, and designates the service candidates of which each selection criteria, value is equal to or higher than the selection criteria value of the current service as service candidates to propose to the provider. In this embodiment, the candidates designator 13 designates SERVICES 1 to 3 including the current SERVICE 1 as candidate services to propose to the provider.

In the above case, the evaluation is conducted on a bus stop basis. From the nature of a bus distribution system, the evaluation can be conducted on one run along a given line (from the starting point to the end point) with consideration for linkage to the bus operation schedule at previous and next bus stops. For example, the total of individual evaluation values regarding multiple stops can be used as the evaluation value of one run of service.

After designating the service candidates to propose to the provider, the candidates designator 13 sends the selection criteria values of the designated service candidates according to the provider selection criteria to the selection criteria adjuster 16. In this case, the service candidates information Ic is the selection criteria values according to the provider selection criteria.

The method of adjusting the provider selection criteria executed by the selection criteria adjuster 16 in the above case of bus distribution system will be described hereafter.

The selection criteria adjuster 16 acquires from the candidates designator 13 the selection criteria values of the designated service candidates, SERVICES 1 to 3, according to the provider selection criteria, for example, 365, 355, and 375 shown in FIG. 6.

The candidates designator 13 creates proposal information Ib presenting SERVICES 1 to 3 and the transmitter 14 sends the proposal information Ib to the provider terminal 7. As the outputter 72 of the provider terminal 7 outputs the proposal information Ib to the display 711 included in the selector 71, the display 711 displays the contents of the proposal information Ib, namely “SERVICE 1,” “SERVICE 2,” and “SERVICE 3.” With reference to the display on the display 711, the provider selects any one of SERVICES 1 to 3 via the selector 71 comprising a touch panel or the like, and provides the selected service to the user. The selector 71 sends provider selection information Ic presenting the service selected by the provider to the service content proposal device 1.

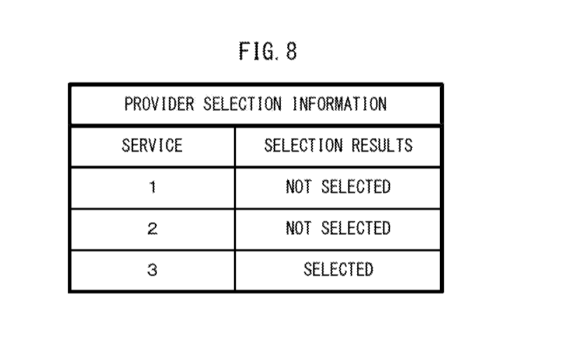

FIG. 8 is a chart showing an example of the provider selection information Ic. In the example of FIG. 8, the provider selects SERVICE 3 from among SERVICES 1 to 3 proposed by the service content proposal device 1. Receiving the provider selection information Ic from the provider selection information receiver 15, the selection criteria adjuster 16 of the service content proposal device 1 determines whether the provider has selected the service of which the selection criteria value according to the provider selection criteria is the highest as the service candidate with reference to the selection criteria values (365, 355, 375) of SERVICES 1 to 3 according to the provider selection criteria. Here, SERVICE 3 selected by the provider has the highest selection criteria value (375) according to the provider selection criteria; therefore, the selection criteria adjuster 16 does not adjust the provider selection criteria value.

If the provider does not select SERVICE 3 of which the selection criteria value according to the provider selection criteria is the highest as the service candidate, the selection criteria adjuster 16 adjusts the evaluation coefficients of the provider selection criteria so that the service selected by the provider has the highest selection criteria value according to the provider selection criteria. For example, if the provider has selected SERVICE 2, the value (10) of the evaluation coefficient of the fare of the provider selection criteria is decreased and the value (10) of the evaluation coefficient of the number of buses and the value (10) of the evaluation coefficient of the additional cost are increased.

Furthermore, when the provider terminal 7 comprises an inputter and receives provider input information presenting the answers to questionnaires entered by the provider via the inputter, the selection criteria adjuster 16 can adjust the values of the evaluation coefficients of the provider selection criteria based on the provider input information. For example, when the provider input information presents a value of a particular parameter evaluation coefficient, the value of the parameter evaluation coefficient of the provider selection criteria is changed to that value. Alternatively, when the provider input information presents the answers to questionnaires that indicate weight on sales, the value of the fare evaluation coefficient of the provider selection criteria is increased.

The method of adjusting the user selection criteria executed by the selection criteria adjuster 16 will be described hereafter.

The selection criteria adjuster 16 adjusts the user selection criteria based on the action information Ia within a given time period that is received by the user information receiver 11 from the user terminal 6. For example, if the action information Ia acquired when SERVICE 3 was selected and provided to the users by the provider indicates that no user took the bus departing at 10:40, presumably, the users put weight on the fare. Then, the selection criteria adjuster 16 increases the value (10) of the fare evaluation coefficient of the user selection criteria,

Furthermore, when the user terminal 6 comprises an inputter and receives user input information presenting the answers to questionnaires entered by the user via the inputter, the selection criteria adjuster 16 can adjust the values of the evaluation coefficients of the user selection criteria based on the user input information. For example, when the user input information indicates that the fare is high, the value (10) of the fare evaluation coefficient of the user selection criteria is increased. Alternatively, when the user input information indicates that the number of buses is low, the value (10) of the evaluation coefficient of the number of buses of the user selection criteria is increased.

In the above service candidates designation method, the method of adjusting the evaluation coefficients executed by the selection criteria adjuster 16 is pre-stored in association with each case.

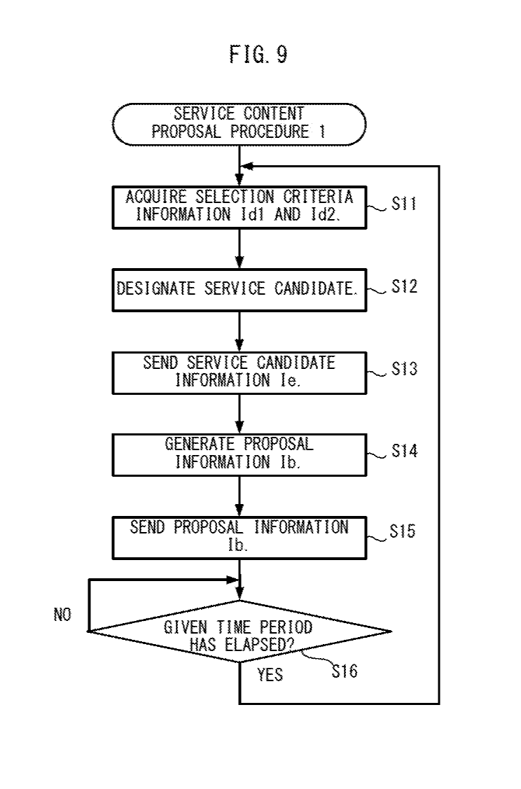

FIG. 9 is a flowchart showing an example of the service content proposal operation according to Embodiment 1. The service content proposal procedure 1 starts when the service content proposal device 1 is powered on.

The candidates designator 13 of the service content proposal device 1 acquires each of selection criteria information Id1 presenting the provider selection criteria and selection criteria information Id2 presenting the user selection criteria from the selection criteria adjuster 16 (Step S11). At this point, this is the first time and then the selection criteria adjuster 16 sends each of the selection criteria information Id1 presenting the default provider selection criteria and the selection criteria information Id2 presenting the default user selection criteria to the candidates designator 13.

The candidates designator 13 calculates the values of given parameters based on the statistical data if regarding the services provided up to the present and stored in the storage 12 and each of the selection criteria information Id1 and Id2 received from the selection criteria adjuster 16. The candidates designator 13 designates one or multiple services of which the values of given parameters satisfy given conditions from among the service candidates stored in the storage 12 as service candidates to propose to the provider (Step S12).

At this point, the candidates designator 13 sends service candidates information Ie presenting the values of given parameters of the designated service candidates to the selection criteria adjuster 16 (Step S13).

The candidates designator 13 creates proposal information Ib presenting the designated service candidates (Step S14) and sends the proposal information Ib to the transmitter 14. The transmitter 14 sends the proposal information Ib received from the candidates designator 13 to the provider terminal 7 (Step S15). If a given time period has not elapsed (Step S16; NO), the Step S16 is repeated. If the given time period has elapsed (Step S16; YES), the processing is returned to the Step S11 and the Steps S11 through S16 are repeated.

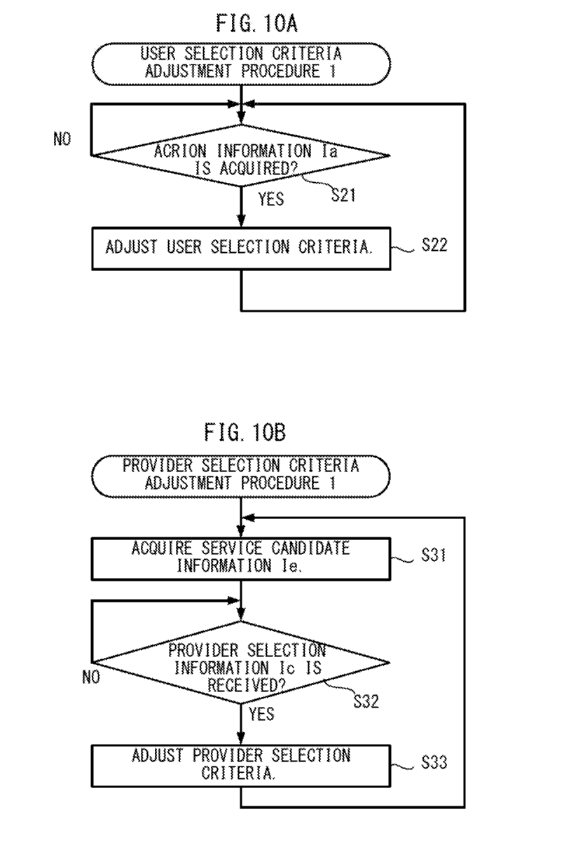

FIGS. 10A and 10B are flowcharts showing an example of the operation to adjust the provider selection criteria and user selection criteria, respectively, according to Embodiment 1.

The user selection criteria adjustment procedure 1 shown in FIG. 10A is executed in parallel to the service content proposal procedure,

First, the service provider provides one or multiple default services to the user. As the user selects and uses a service, the detector 611 of the user terminal 6 detects the service selected by the user and the action of the user having used the selected service, and successively sends action information Ia presenting the detected action to the service content proposal device 1.

The user information receiver 11 of the service content proposal device 1 sends the action information Ia within a given time period to the selection criteria adjuster 16 at given time intervals. The selection criteria adjuster 16 determines whether the action information Ia is already acquired (Step S21). If no action information Ia is acquired (Step S21; NO), the Step S21 is repeated. If the action information Ia is already acquired (Step S22; Yes), the selection criteria adjuster 16 adjusts the user selection criteria based on the action information Ia received from the user information receiver 11 (Step S22). From then on, the processing is returned to the Step S21 and the Steps S21 and S22 are repeated.

The provider selection criteria adjustment procedure 1 shown in FIG. 10B is executed in parallel to the service content proposal procedure 1 shown in FIG. 9.

In the Step S13 of the flowchart in FIG. 9, the candidates designator 13 sends the service candidates information Ie presenting the values of given parameters of the designated service candidates (FIG. 5) to the selection criteria adjuster 16. Then, the selection criteria adjuster 16 acquires the service candidates information Ie from the candidates designator 13 (Step S31).

As the transmitter 14 sends the proposal information Ib to the provider terminal 7 in the Step S15 of the flowchart in FIG. 9, the outputter 72 of the provider terminal 7 outputs the proposal information Ib received from the service content proposal device 1. If the service provider selects via the selector 71 a service to provide from among the service candidates presented by the proposal information Ib, the selector 71 sends the provider selection information Ic presenting the service selected by the provider (FIG. 8) to the service content proposal device 1.

If the provider selection information receiver 15 of the service content proposal device 1 receives no provider selection information Ic from the provider terminal 7 (Step S32; NO), the Step S32 is repeated. If the provider selection information receiver 15 receives the provider selection information Ic from the provider terminal 7 (Step S32; YES), the selection criteria adjuster 16 adjusts the provider selection criteria based on the service candidates information Ie received from the candidates designator 13 and the provider selection information Ic received from the provider selection information receiver 15 (Step S33). From then on, the processing is returned to the Step S31 and the Steps S31 through S33 are repeated.

Another service candidates designation method will be described hereafter.

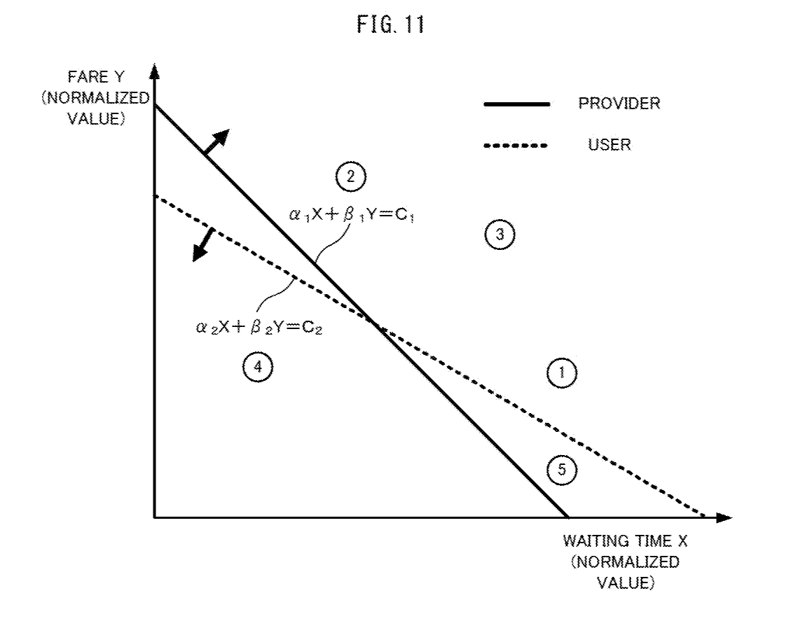

FIG. 11 is a graphical representation for explaining an example of the other exemplary service candidates designation method according to Embodiment 1. In the case of FIG. 11, for easier understanding, the focus is on two parameters, “fare” and “waiting time,” and they are presented in a two-dimensional space.

In this method, the provider selection criteria and user selection criteria presented by the selection criteria information Id1 and Id2, respectively, are each excessed by a formula comprising a variable Y presenting the normalized value of “the fare,” a variable X presenting the normalized value of “the waiting time,” and a constant. The variables in the provider selection criteria and the variables in the user selection criteria are associated with evaluation coefficients defining the characteristics of the provider selection criteria and evaluation coefficients defining the characteristics of the user selection criteria, respectively. Normalization coefficients for normalizing the values of the parameters are preset for each of the parameters. The provider selection criteria and user selection criteria share the same normalization coefficients for the parameters. The candidates designator 13 presents the equation of the provider selection criteria and the equation of the user selection criteria in a two-dimensional space expressed by the two parameters “fare” and “waiting time.” In the case of FIG. 11, the solid line presents the provider selection criteria and the dotted line presents the user selection criteria. The provider selection criteria and user selection criteria are each presented by a line on which the total of evaluation values of the parameters to be evaluated by the provider or user (the parameters “fare” and “waiting time”) is constant and the ratio of the evaluation coefficients defines the gradient.

For the provider, shorter waiting times mean a larger number of buses and higher cost; thus, the provider desires higher fares. For the user, longer waiting times are disadvantageous; thus, the user wishes a lower fare. As just mentioned, it is assumed that the evaluation values of the “fare” and “waiting time” of the provider selection criteria and user selection criteria shift in the opposite directions. In the case of FIG. 11, the provider selection criteria and user selection criteria are presented by lines. However, they can be presented by curved lines. Furthermore, the provider selection criteria and user selection criteria are presented by graphs. However, they can be presented in a table format or by functions.

The candidates designator 13 calculates the values of the “fare” and “waiting time,” normalizes the values by multiplying them by the normalization coefficients, and plots the results as a graph. The circled numbers in FIG. 11 present the numbers to identify the service candidates and SERVICES 1 to 5 are plotted.

The provider selection criteria and user selection criteria present the lowest standards acceptable to the provider and the user, respectively. In other words, since the provider desires to increase the fare, the region in which the value of the ordinate is higher than the provider selection criteria (in the figure, the region in the direction indicated by the arrow on the solid line) is the acceptable range. Since the user desires to lower the fare and reduce the waiting time, the region in which the values of the ordinate and abscissa are lower than the user selection criteria (in the figure, the region in the direction indicated by the arrow on the dotted line) is the acceptable range. Here, the candidates designator 13 can also plot the current service on the graph. For example, if the current service is SERVICE 1, it can be seen that the current service is more advantageous for the provider than for the user and situated outside the user acceptable range.

The candidates designator 13 designates the service candidates plotted in the region contained in both the provider acceptable range and user acceptable range as service candidates to propose to the provider. In the case of FIG. 11, only SERVICE 5 is designated as the service candidate. The candidates designator 13 sends the coordinates of the designated service candidate to the selection criteria adjuster 16. In other words, in the (second) service candidate designation method in FIG. 11, the service candidates information Ie is the coordinates of the designated service candidates.

If there is no service candidate within the region contained in both the provider acceptable range and user acceptable range (in the figure, the overlapped region of the region in the direction indicated by the arrow on the solid line and the region in the direction indicated by the arrow on the dotted line), it is possible that the candidates designator 13 sends an error to the transmitter 14 and the selection criteria adjuster 16 receives this result and adjusts the provider selection criteria and/or user selection criteria.

More specifically, the selection criteria adjuster 16 adjusts the evaluation coefficients and/or constants in the formulae presenting the provider selection criteria and user selection criteria so that the service selected by the provider is contained in the provider acceptable range or the service selected by the user is contained in the user acceptable range. The provider selection criteria and user selection criteria can be adjusted by changing the gradient or constant of the selection criteria.

Incidentally, when n parameters are used, the candidates designator 13 presents the formulae of the provider selection criteria and user selection criteria in a n-dimensional space, and obtains the provider acceptable range and user acceptable range. Then, the candidates designator 13 designates the services present in the region contained in both the provider acceptable range and user acceptable range as service candidates to propose to the provider.

When the provider selection criteria and user selection criteria are each expressed by a formula comprising a variable Y presenting the normalized value of “the fare,” a variable X presenting the normalized value of “the waiting time,” evaluation coefficients α and β, and a constant C (for example, αX+βY=C), the selection criteria adjuster 16 changes the evaluation coefficients α₁, α₂, β₁, and β₂ and/or constants C₁ and C₂ in the formula (α₁X+β₁Y=C₁) presenting the provider selection criteria and the formula (α₂X+β₂Y=C₂) presenting the user selection criteria to adjust the provider selection criteria and user selection criteria separately.

The selection criteria adjuster 16 adjusts the provider selection criteria, based on the provider selection information Ic received from the provider selection information receiver 15 and the coordinates of the designated service candidates received from the candidates designator 13. For example, if the service selected by the provider does not have the highest value of the parameter “fare” and has the lowest value of the parameter “waiting time” among the service candidates presented by the proposal information Ib, presumably, the provider puts weight on the user waiting time. Then, the selection criteria adjuster 16 increases the evaluation coefficient (α₁) in the formula of the provider selection criteria, to increase the pitch of the gradient (−α₁/β₁). In the case of FIG. 11, the y-axis intercept (C₁/β₁) of the line (solid line) of the formula of the provider selection criteria is unchanged, but the x-axis intercept (C₁/α₁) is decreased; therefore, the negative gradient is augmented.

Furthermore, when the provider terminal 7 comprises an inputter and receives provider input information presenting the answers to questionnaires entered by the provider via the inputter, the selection criteria adjuster 16 can adjust the provider selection criteria based on the provider input information. For example, when the provider input information presents the formula of different provider selection criteria, the formula of the current provider selection criteria (α₁X+β₁Y=C₁) is changed to the formula of the different provider selection criteria (for example, α₃X+β₃Y=C₃). Alternatively, when the provider input information is the answers to questionnaires that indicate weight on sales, the evaluation coefficient (β₁) in the formula of the provider selection criteria (α₁X+β₁Y=C₁) is towered to increase the pitch of the gradient (−α₁/β₁). In the case of FIG. 11, the x-axis intercept (C₁/α₁) of the line (solid line) of the formula of the provider selection criteria is unchanged, but the y-axis intercept (C₁/β₁) is increased; therefore, the negative gradient is augmented.

The selection criteria adjuster 16 adjusts the user selection criteria based on the action information Ia within a given time period that is received by the user information receiver 11 from the user terminal 6. For example, if no user took the high fare bus, presumably, the users prefer a lower fare. Then, the selection criteria adjuster 16 lowers the value of the constant (C₂) in the formula of the user selection criteria (α₂X+β₂Y=C₂). In the case of FIG. 11, the x-axis intercept (C₂/α₂) and y-axis intercept (C₂/β₂) of the line (dotted line) of the formula of the user selection criteria are both decreased, but the gradient (−α₂/β₂) is unchanged. Consequently, the line (dotted line) of the above formula moves in the arrowed direction in the figure (to the bottom left).

Furthermore, when the user terminal 6 comprises an inputter and receives user input information presenting the answers to questionnaires entered by the user via the inputter, the selection criteria adjuster 16 can adjust the user selection criteria based on the user input information. For example, if the user input information indicates that the fare is high, the value of the constant (C₂) in the formula of the user selection criteria (α₂X+β₂Y=C₂) is lowered. Alternatively, if the user input information indicates that the waiting time is long, the evaluation coefficient (α₂) in the formula of the user selection criteria (α₂X+β₂Y=C₂) is increased to augment the pitch of the gradient (−α₂/β₂).

In this service candidates designation method, the method of adjusting the evaluation coefficients and/or constant executed by the selection criteria adjuster 16 is pre-stored in association with each case.

Incidentally, one provider provides services in this embodiment. However, multiple providers can provide services. In such a case, the storage 12 stores service candidates for multiple providers. The candidates designator 13 designates service candidates to propose to each provider from among the service candidates stored in the storage 12 for the provider based on the statistical data If regarding the services of the provider provided up to the present and stored in the storage 12, the provider selection criteria of the provider, and the user selection criteria. The selection criteria adjuster 16 stores the provider selection criteria of multiple providers and the user selection criteria, and adjusts the provider selection criteria of each provider based on the provider selection information Ic from the provider that is received from the provider selection information receiver 15 and the service candidates information Ie received from the candidates designator 13.

Furthermore, when services can be provided concurrently or services of a provider are linked, the storage 12 stores conditions information presenting conditions enabling two or more services to be provided concurrently or settings for services to be linked. The candidates designator 13 determines whether a service candidate is executable based on the conditions information. If not executable, the candidates designator 13 may send the provider an instruction to make the service executable.

As described above, in the service content proposal system 100 of Embodiment 1, the service content proposal device 1 can automatically adjust (learn) the provider selection criteria and user selection criteria and propose to the provider service candidates based on both the provider selection criteria and user selection criteria. Consequently, it is possible to quickly adjust the service contents provided by the service provider, suppress increase in cost due to long-run service contents unsuited for the actual use, and reduce complaints from the service users.

For example, when the users use the buses differently in a bus distribution system (for example, a holiday is moved due to power saving measures and commuting rush hours occur on a different day of the week, or in the school trip season), the bus distribution suitable for the actual use can be realized.

### Modified Embodiment

The user terminal 6 can comprise an inputter receiving input from the service user. For example, the user accesses a web site of the service provider using the user terminal 6 and answers via the inputter to questionnaires regarding the service the user has used. At this point, the inputter sends user input information presenting the input content to the service content proposal device 1 through operation of the user.

Furthermore, the provider terminal 7 can comprise an inputter receiving input from the service provider. For example, the provider accesses its own web site using the provider terminal 7 and answers via the inputter to questionnaires regarding the service to provide. Alternatively, the provider enters into the inputter a request for service content proposal from the service content proposal device 1. At this point, the inputter sends provider input information presenting the content entered by the provider to the service content proposal device 1 through operation of the provider.

When the user terminal 6 comprises an inputter, the selection criteria adjuster 16 can adjust the user selection criteria based on the user input information received from the inputter. When the provider terminal 7 comprises an inputter, the selection criteria adjuster 16 can adjust the provider selection criteria based on the provider input information received from the inputter. Furthermore, it is possible that the storage 12 stores the provider selection criteria and user selection criteria and the selection criteria adjuster 16 calls for and adjusts the provider selection criteria and user selection criteria from the storage 12.

In the flowchart of FIG. 9, the proposal information Ib is automatically sent to the provider terminal 7 each time a given time period has elapsed. This is not restrictive. When the provider terminal 7 comprises an inputter, it is possible to determine whether provider input information presenting a request for service content proposal is received from the inputter and execute the Steps S11 through S15 only when a request for service content proposal is made.

The candidates designator 13 can calculate a selection criteria value according to the provider selection criteria and a selection criteria value according to the user selection criteria for the service candidates stored in the storage 12, and designate a given number of services in the descending order of selection criteria value from the highest as service candidates to propose to the provider. Furthermore, the current service does not need to be included in the service candidates to propose to the provider. However, with the current service being included in the service candidates to propose to the provider, the provider can select the status quo.

### Embodiment 2

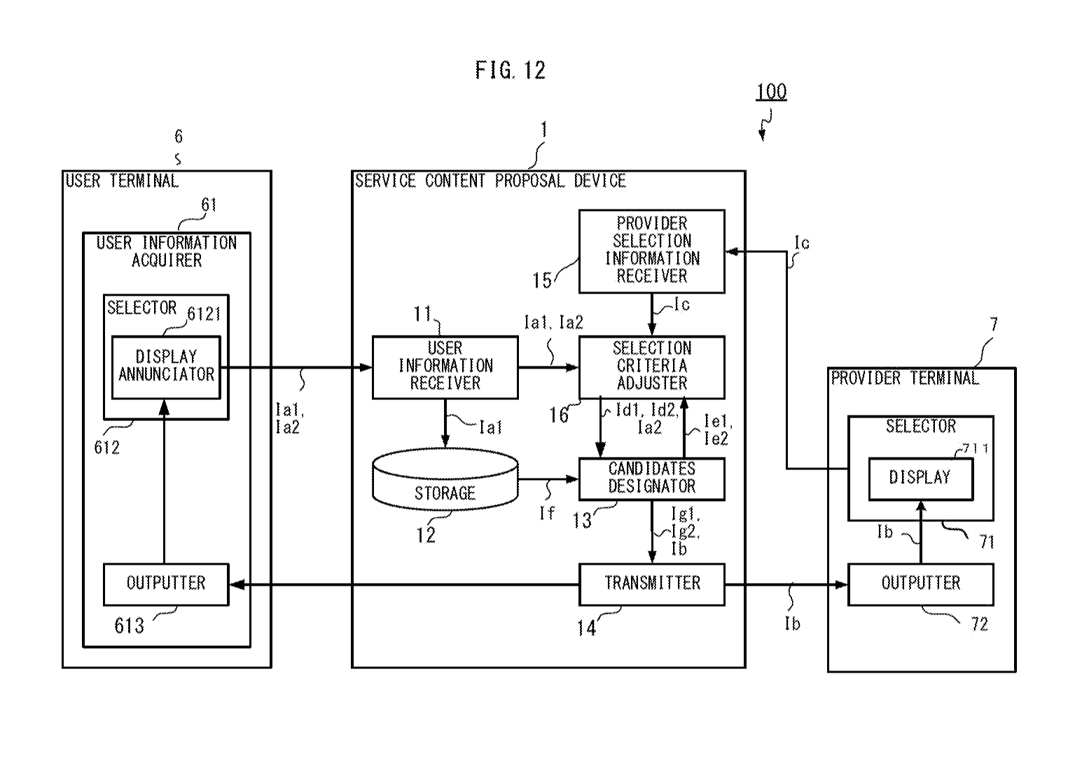

FIG. 12 is a block diagram showing an exemplary configuration of a service content proposal system 200 according to Embodiment 2 of the present disclosure. The service content proposal system 200 of Embodiment 2 comprises, like the service content proposal system 100 of Embodiment 1, a service content proposal device 1, a user terminal 6, and a provider terminal 7. The user terminal 6, provider terminal 7, and service content proposal device 1 are mutually communicable via a network. Furthermore, one user terminal 6 and one provider terminal 7 are representatively shown; however, multiple user terminals 6 and multiple provider terminals 7 may be connected to the network. In this embodiment, one provider provides services.

The user terminal 6 comprises a user information acquirer 61 acquiring user information including information regarding a service selected by the user and information regarding the action of the user using the selected service. In this embodiment, the user information acquirer 61 comprises a selector 612 comprising a touch panel or the like and receiving selection of a service by the user and an outputter 613 outputting information received from the service content proposal device 1 in place of the detector 611 detecting the action of the user using the service. The selector 612 comprises a display annunciator 6121 displaying or reading aloud information output by the outputter 613. The outputter 613 receives presentation information presenting user service candidates the service content proposal device 1 presents to the user, and displays as an image or outputs as sound the presentation information Ig1 through the display annunciator 6121.

The service user enters selection of a service he wishes to use and information regarding the user's action of using the service (for example, the time the user arrives at the site where the service is provided) via the selector 612. The selector 612 sends user selection information Ia1 including the information regarding the service selected by the user and information regarding the user's action of using the service to the service content proposal device 1. In other words, in this embodiment, the user information is the user selection information Ia1.

Here, the service user can make a reservation for a service to use via the selector 612 from among the user service candidates presented by the presentation information Ig1 output by the outputter 613. In such a case, the selector 612 sends reservation information Ia2 presenting the reserved service to the service content proposal device 1.

The provider terminal 7 has the same configuration as in Embodiment 1.

The user information receiver 11 of the service content proposal device 1 of Embodiment 2 receives the user selection information Ia1 from the user terminal 6. The user information receiver 11 sends the user selection information Ia1 received within a given time period to the storage 12 and selection criteria adjuster 16 at given time intervals. When the service user makes a reservation for a service to user via the selector 612 from among the user service candidates presented by the presentation information Ig1 output by the outputter 613, the user information receiver 11 receives the reservation information Ia2 from the user terminal 6.

The storage 12 pre-stores the service candidates the service provider can provide. The storage 12 further stores information on the current service. The information on the current service includes the latest user selection information Ia1 within a given time period that is received from the user information receiver 11. The storage 12 further stores statistical data if of the services provided up to the present, which are accumulated information on the current service.

The candidates designator 13 receives from the selection criteria adjuster 16 selection criteria information Id1 and Id2 presenting the provider selection criteria and user selection criteria, respectively, including given parameters. The candidates designator 13 designates user service candidates to present to the user from among the service candidates stored in the storage 12 based on the statistical data If and the provider selection criteria and user selection criteria presented by the selection criteria information Id1 and Id2, respectively. The candidates designator 13 creates presentation information Ig1 presenting the designated user service candidates and sends the presentation information Ig1 to the transmitter 14. Furthermore, the candidates designator 13 sends to the selection criteria adjuster 16 user service candidates information lei presenting the values of given parameters of the designated user service candidates. The user service candidates designation method is the same as the service candidates designation method in Embodiment 1.

Receiving the user selection information Ia1 from the user information receiver 11, the candidates designator 13 refines the user service candidates based on the user selection information Ia1 and designates provider service candidates to propose to the provider. The candidates designator 13 creates proposal information Ib presenting the designated provider service candidates and sends the proposal information Ib to the transmitter 14. Furthermore, the candidates designator 13 sends to the selection criteria adjuster 16 provider service candidates information Ie2 presenting the values of given parameters of the designated provider service candidates.

The transmitter 14 sends the presentation information received from the candidates designator 13 to the user terminal 6. The transmitter 14 further sends the proposal information received from the candidates designator 13 to the provider terminal 7,

The provider selection information receiver 15 receives the provider selection information Ic from the provider terminal 7. The provider selection information receiver 15 sends the received provider selection information Ic to the selection criteria adjuster 16. In the case of the user information receiver 11 receiving the reservation information Ia2 from the user terminal 6, the candidates designator 13 receives the reservation information Ia2 via the selection criteria adjuster 16, creates cancelation information Ig2 presenting cancellation of the reservation to the user who made a reservation for a service that is not selected in the provider selection information ic received by the provider selection information receiver 15, and instructs the transmitter 14 to send the cancellation information Ig2 to the corresponding user terminal 6.

The selection criteria adjuster 16 stores the provider selection criteria and user selection criteria, and sends to the candidates designator 13 selection criteria information Id1 and Id2 presenting the provider selection criteria and user selection criteria, respectively. Furthermore, the selection criteria adjuster 16 adjusts the user selection criteria based on the user selection information Ia1 received from the user information receiver 11 and the user service candidates information Ie1 received from the candidates designator 13. Furthermore, the selection criteria adjuster 16 adjusts the provider selection criteria based on the provider selection information Ic received from the provider selection information receiver 15 and the provider service candidates information Ie2 received from the candidates designator 13.

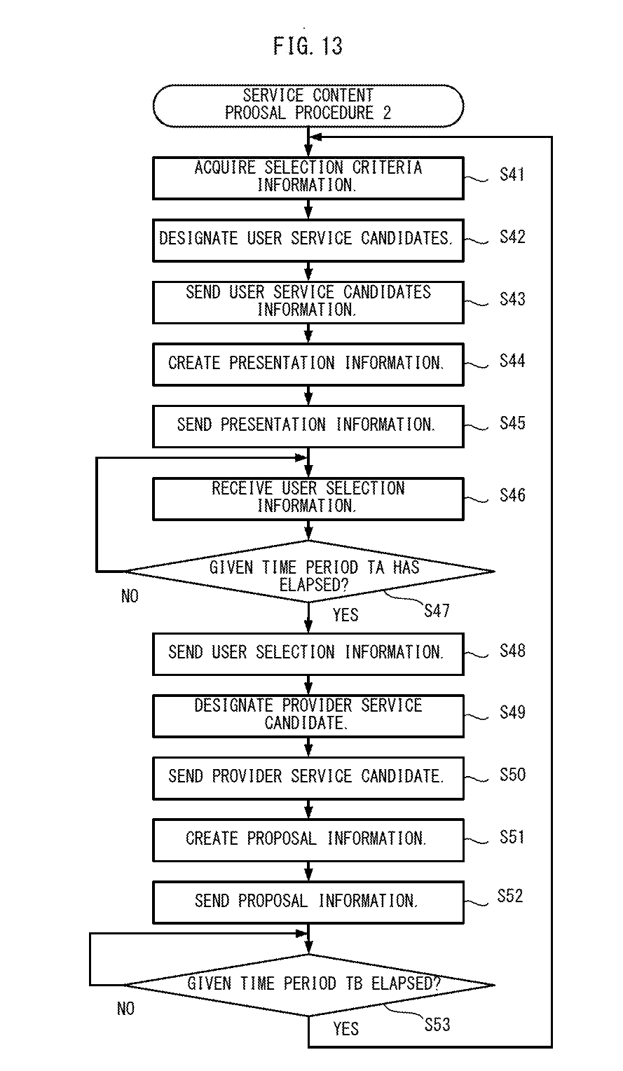

FIG. 13 is a flowchart showing an example of the service content proposal operation according to Embodiment 2. The service content proposal procedure 2 starts when the service content proposal device 1 is powered on.

First, the candidates designator 13 of the service content proposal device 1 acquires the selection criteria information Id1 and Id2 presenting the provider selection criteria and user selection criteria, respectively, from the selection criteria adjuster 16 (Step S41). At this point, this is the first time and then the selection criteria adjuster 16 sends the selection criteria information Id1 presenting the default provider selection criteria and the selection criteria information Id2 presenting the default user selection criteria to the candidates designator 13.

The candidates designator 13 calculates the values of given parameters based on the statistical data If regarding the services provided up to the present and stored in the storage 12 and each of the selection criteria information Id1 and Id2 received from the selection criteria adjuster 16. The candidates designator 13 designates the services of which the values of given parameters satisfy given conditions from among the service candidates stored in the storage 12 as user service candidates to present to the user (Step S42). At this point, the candidates designator 13 sends to the selection criteria adjuster 16 user service candidates information Ie1 presenting the values of given parameters of the designated user service candidates (Step S43).

The candidates designator 13 creates presentation information Ig1 presenting the designated user service candidates (Step S44) and sends the presentation information Ig1 to the transmitter 14. The transmitter 14 sends the presentation information Ig1 received from the candidates designator 13 to the user terminal 6 (Step S45).

As the transmitter 14 sends the presentation information Ib to the user terminal 7, the outputter 613 of the user terminal 7 outputs the presentation information Ig1 received from the service content proposal device 1 to the selector 612. The display annunciator 6121 of the selector 612 displays as an image and outputs as sound the user service candidates to present to the user that are presented by the presentation information Ig1. When the service user selects a service to be provided via the selector 612 from among the user service candidates presented by the presentation information the selector 612 sends user selection information presenting the service selected by the user to the service content proposal device 1.

If a given time period TA has not elapsed (Step S47; NO), the user information receiver 11 of the service content proposal device 1 continues to receive the user selection information Ia1 from the user terminal 6 (Step S46). If the given time period TA has elapsed (Step S47; YES), the user information receiver 11 sends the latest user selection information Ia1 received within the given time period TA to the candidates designator 13 via the selection criteria adjuster 16 (Step S48).

The candidates designator 13 refines the user service candidates based on the user selection information Tail received from the user information receiver and designates provider service candidates to propose to the provider (Step S49). At this point, the candidates designator 13 sends to the selection criteria adjuster 16 provider service candidates information Ie2 presenting the values of given parameters of the designated provider service candidates (Step S50).

The candidates designator 13 creates proposal information Ib presenting the designated provider service candidates (Step S51) and sends the proposal information Ib to the transmitter 14. The transmitter 14 sends the proposal information Ib received from the candidates designator 13 to the provider terminal 7 (Step S52).

If a given time period TB has not elapsed (Step S53; NO), the Step S53 is repeated. If the given time period TB has elapsed (Step S53; YES), the processing is returned to the Step S41 and the Steps S41 through S53 are repeated.

Incidentally, in the flowchart of FIG. 13, the proposal information Ib is automatically sent to the provider terminal 7 each time the given time period TB has elapsed. This is not restrictive. When the provider terminal 7 comprises an inputter, it is possible that the service content proposal device 1 determines whether provider input information presenting a request for service content proposal is received from the inputter and executes the Steps S41 through S52 only when a request for service content proposal is made.

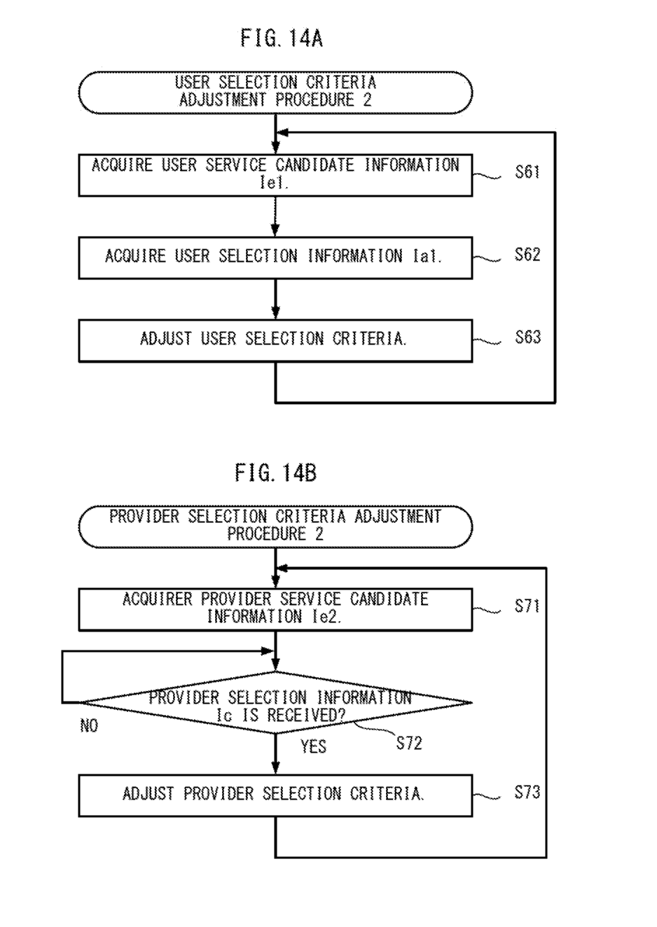

FIGS. 14A and 14B are flowcharts showing an example of the operation to adjust the provider selection criteria and user selection criteria according to Embodiment 2.

The user selection criteria adjustment procedure 2 shown in FIG. 14A is executed in parallel to the service content proposal procedure 2.

In the Step S43 of the flowchart in FIG. 13, the candidates designator 13 sends the user service candidates information Ie1 presenting the values of given parameters of the designated user service candidates to the selection criteria adjuster 16. Then, the selection criteria adjuster 16 acquires the user service candidates information Ie1 from the candidates designator 13 (Step S61).

In the Step S48 of the flowchart in FIG. 13, the user information receiver 11 sends the received user selection information Ia1 to the selection criteria adjuster 16. Then, the selection criteria adjuster 16 receives the user selection information Ia1 from the user information receiver 11 (Step S62).

The selection criteria adjuster 16 adjusts the user selection criteria based on the user service candidates information Ie1 received from the candidates designator 13 and the user selection information Ia1 received from the user information receiver 11 (Step S63). From then on, the processing is returned to the Step S61 and the Steps S61 through S63 are repeated.

The provider selection criteria adjustment procedure 2 shown in FIG. 14B is executed in parallel to the service content proposal procedure 2.

In the Step S50 of the flowchart in FIG. 13, the candidates designator 13 sends the provider service candidates information Ie2 presenting the values of given parameters of the designated provider service candidates to the selection criteria adjuster 16. Then, the selection criteria adjuster 16 acquires the provider service candidates information Ie2 from the candidates designator 13 (Step S71).

As the transmitter 14 sends the proposal information Ib to the provider terminal 7 in the Step S52 of the flowchart in FIG. 13, the outputter 72 of the provider terminal 7 outputs the proposal information Ib received from the service content proposal device 1. When the service provider selects a service to provide via the selector 71 from among the provider service candidates presented by the proposal information Ib, the selector 71 sends the provider selection information Ib presenting the service selected by the provider to the service content proposal device 1.

If the provider selection information receiver 15 of the service content proposal device 1 receives no provider selection information Ic from the provider terminal 7 (Step S72: NO), the Step S72 is repeated. If the provider selection information receiver 15 receives the provider selection information Ic from the provider terminal 7 (Step S72: YES), the selection criteria adjuster 16 adjusts the provider selection criteria based on the latest provider service candidates information Ie2 received from the candidates designator 13 and the provider selection information ic received from the provider selection information receiver 15 (Step S73). From then on, the processing is returned to the Step S71 and the Steps 71 through S73 are repeated.

A case in which this embodiment is applied to a bus distribution system will be described hereafter. In this case, the user selection information Ic includes a service selected by the user and the time the user arrives at the bus stop.

The candidates designator 13 of the service content proposal device 1 calculates the actual use of the current service based on information presenting the current service such as the bus operation schedule and fares of the current service stored in the storage 12 and the latest user selection information Ie1 within a given time period TA. The candidates designator 13 further calculates the prospective use of the service candidates stored in the storage 12 based on the bus operation schedule and fares of the service candidates stored in the storage 12 and the statistical data If of the services provided up to the present including information on the current service.

The candidates designator 13 calculates the values of parameters included in each of the provider selection criteria and user selection criteria for the actual use of the current service and prospective use of the service candidates stored in the storage 12.

In this embodiment, the provider selection criteria and user selection criteria each include two parameters, “waiting time” presenting the average waiting time and “fare” presenting the average fare.

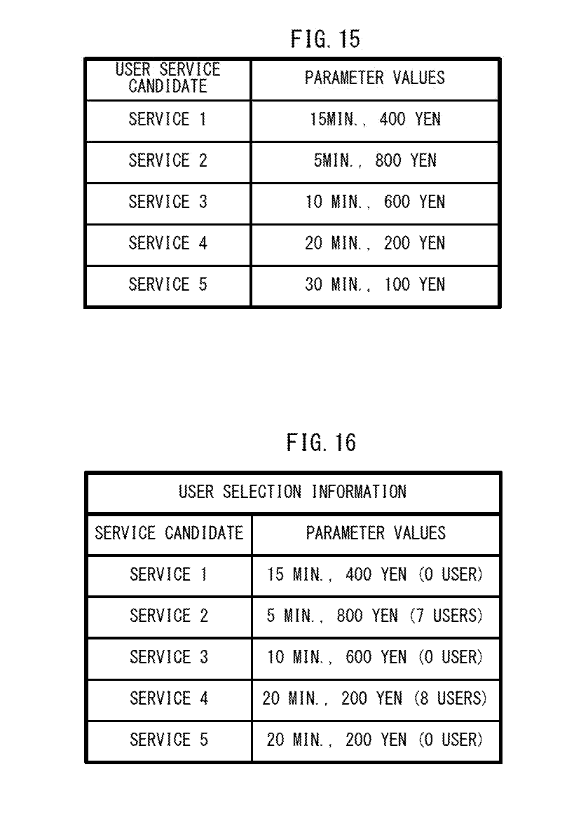

FIG. 15 is a chart presenting the values of the parameters of the user service candidates including the current service according to Embodiment 2. The candidates designator 13 calculates the values of the two parameters (waiting time and fare) for SERVICES 1 to 5 including the current SERVICE 1.

The values of the parameters of SERVICE 1 are (15 min., 400 yen). The values of the parameters of SERVICE 2 are (5 min., 800 yen). The values of the parameters of SERVICE 3 are (10 min., 600 yen). The values of the parameters of SERVICE 4 are (20 min., 200 yen). The values of the parameters of SERVICE 5 are (30 min., 100 yen).

In this case, the candidates designator 13 designates SERVICES 1 to 5 including the current service as user service candidates to present to the user. Incidentally, the current service does not need to be included in the user service candidates to propose to the provider. However, with the current service being included in the user service candidates to present to the user, the user can select the status quo.

FIG. 16 is a chart showing an example of the user selection information. In the example of FIG. 16, seven users have selected SERVICE 2 and eight users have selected SERVICE 4. Receiving the user selection information Ia1 as shown in FIG. 16 from the user information receiver 11, the candidates designator 13 refines the user service candidates (SERVICES 1 to 5) to SERVICES 2 and 4 and designates provider service candidates to propose to the provider (SERVICES 2 and 4). The candidates designator 13 creates proposal information Ib presenting the designated provider service candidates and sends the proposal information Ib to the transmitter 14.

According to the user selection information Ie1 in FIG. 16, the users are divided into those who have selected SERVICE 2 and those who have selected SERVICE 4. Then, the users can be divided into two classes A and B. Seven users who have selected SERVICE 2 belong to the class A and eight users who have selected SERVICE 4 belong to the class B.

The selection criteria adjuster 16 creates user selection criteria for each user class (classes A and B) from the original user selection criteria. In the case of using the service candidates designation method described first in Embodiment 1 (the first service candidates designation method), the selection criteria adjuster 16 adjusts the evaluation coefficients of the user selection criteria of each user class so that the service (SERVICE 2 or SERVICE 4) selected by the users in the user class has the highest selection criteria value according to the user selection criteria. The method of adjusting the evaluation coefficients executed by the selection criteria adjuster 16 is pre-stored in association with each case.

In the case of using the second service candidates designation method described in Embodiment 1, the selection criteria adjuster 16 adjusts the evaluation coefficients and/or constant in the formula presenting the user selection criteria of each user class no that the service selected by the users in the user class is contained in both the provider acceptable range and the user class acceptable range. The method of adjusting the coefficients and/or constant executed by the selection criteria adjuster 16 is pre-stored in association with each case.

The candidates designator 13 designates user service candidates to present to the user for each user class (classes A and B). Receiving the user selection information from the user information receiver 11 on a user class basis, the candidates designator 13 refines the user service candidates based on the user selection information Ia1 and designates provider service candidates to propose to the provider for each user class. The candidates designator 13 creates proposal information Ib presenting the provider service candidates for each user class (SERVICE 2 for the class A and SERVICE 4 for the class B), and the transmitter 14 sends the proposal information Ib to the provider terminal 7.

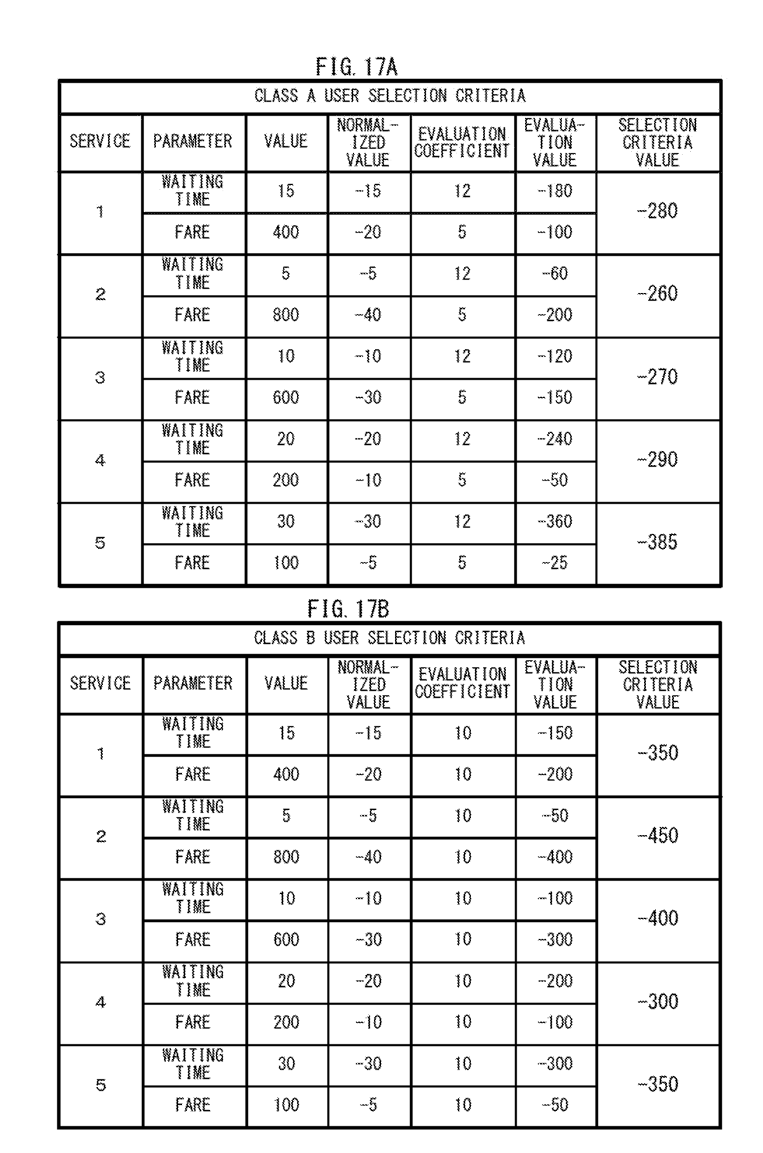

FIGS. 17A and 1713 are charts for explaining the calculation of the selection criteria value based on the user selection criteria of each user class (classes A and B). For example, the values of the parameters “waiting time” and “fare” of SERVICES 1 to 5 shown in FIG. 15 are entered into the user selection criteria of each user class to calculate the selection criteria value. Then, the selection criteria value of SERVICE 1 according to the class A is −280; the selection criteria value of SERVICE 2, −260; the selection criteria value of SERVICE 3, −270 the selection criteria value of SERVICE 4, −290; and the selection criteria value of SERVICE 5, −385. Thus, in the case of designating the service candidates of which the total of selection criteria values is equal to or higher than the total of selection criteria value of the current service (SERVICE 4) (−290) as user service candidates, the candidates designator 13 presents SERVICES 1, 2, and 3 to the users in the class A as user service candidates.

On the other hand, the selection criteria value of SERVICE 1 according to the class B is −350; the selection criteria value of SERVICE 2, −450; the selection criteria value of SERVICE 3, −400; the selection criteria value of SERVICE 4, −300; and the selection criteria value of SERVICE 5, −350. Thus, in the case of designating the service candidates of which the total of selection criteria values is equal to or higher than the total of selection criteria values of the current service (SERVICE 3) (−400) as user service candidates, the candidates designator presents SERVICES 1, 4, and 5 to the users in the class B as user service candidates.

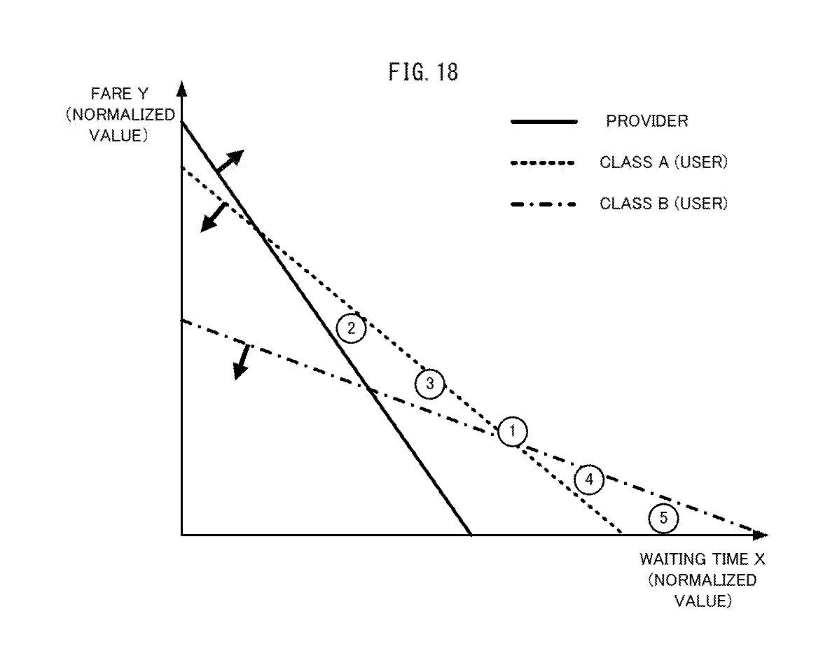

FIG. 18 is a graphical representation for explaining an example of the second service candidates designation method according to Embodiment 2. FIG. 18 shows the normalized values of the parameters “waiting time” and “fare” of SERVICES 1 to 5 shown in FIG. 15 in a two-dimensional space by way of example. In the example of FIG. 18, the solid line presents the provider selection criteria, the dotted line presents the class A user selection criteria, and the dash-dot line presents the class B user selection criteria.

The candidates designator 13 presents to the class A users the current service of SERVICE 1, and user service candidates of SERVICES 2 and 3 present in the region contained in both the provider acceptable range (the region in the arrowed direction from the solid line) and the user acceptable range (the region in the arrowed direction from the dotted line). The candidates designator 13 presents to the class B users the current service of SERVICE 1 and user service candidates of SERVICES 4 and 5 present in the region contained in both the provider acceptable range and the user acceptable range.

The provider selection criteria adjustment method and other configurations are the same as those in Embodiment 1. Furthermore, one provider provides services in this embodiment. However, multiple providers can provide services. In such a case, the mode when multiple providers provide services in Embodiment 1 can apply.

As described above, in the service content proposal system 200 of Embodiment 2, the service content proposal device 1 automatically learns the provider selection criteria and user selection criteria and proposes to the provider one or multiple services as service candidates based on both the provider selection criteria and user selection criteria, whereby it is possible to quickly adjust the service contents provided by the service provider, suppress increase in cost due to long-run service contents unsuited for the actual use, and reduce complaints from the service users.

Furthermore, allowing the user to pre-select a service can be expected to increase the user satisfaction. Furthermore, since the user can select a service he wishes to use from among the presented service candidates and enter information regarding the user's action of using the service (for example, the time the user arrives at the site where the service is provided), the user terminal 6 does not need to detect information regarding the action and the cost is reduced.

Although described above separately, Embodiments 1 and 2 can be combined. In such a case, the user information acquirer 61 comprises a detector 611 detecting information regarding the action of the user using the service, a selector 612 receiving selection of a service by the user, and an outputter 613 outputting information received from the service content proposal device 1. Furthermore, the user information receiver 11 of the service content proposal device 1 receives the information regarding the action and user selection information Ia1 from the user terminal 6, and the statistical data If regarding the services provided up to the present and stored in the storage 12 includes the information regarding the action and user selection information Ia1.

In the above embodiments, the storage 12 stores service candidates the service provider can provide, and the candidates designator 13 designates service candidates to propose to the provider from among the service candidates stored in the storage 12 based on the statistical data If regarding the services provided up to the present and stored in the storage 12 and each of the provider selection criteria and user selection criteria. The present discloser is not confined thereto. It is possible that the storage 12 stores information such as the service contents the service provider provided in the past, resource restrictions (for example, the upper limit of the number of buses), and service conditions (the distance between bus stops and the like), and the candidates designator 13 creates service candidates to propose to the provider based on the above information stored in the storage 12, statistical data If of the services provided up to the present, and the provider selection criteria and user selection criteria.

In such a case, in the first service candidates designation method, the candidates designator 13 creates a given number of service candidates of which the total of the selection criteria value according to the provider selection criteria and the selection criteria value according to the user selection criteria is higher than the total of those of the current service, and creates proposal information Ib presenting the created service candidates. On the other hand, in the second service candidates designation method, the candidates designator 13 creates a given number of service candidates present in the region contained in both the provider acceptable range and user acceptable range, and creates proposal information Ib presenting the created service candidates.

In the above-described embodiments, there are six parameters. This is not restrictive. Furthermore, the provider can adopt any parameters from among those parameter.

In the above-described embodiments, the present disclosure is applied to a bus distribution system. This is not restrictive. The present disclosure is applicable to services successively provided to multiple users and involving at least waiting time, service fares, and limited resources.

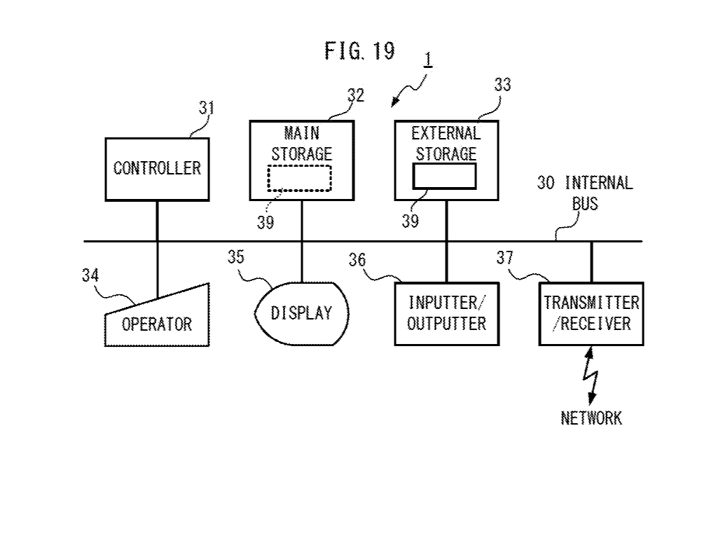

FIG. 19 is a block diagram showing an exemplary hardware configuration of the service content proposal device according to the embodiments of the present disclosure. The service content proposal device 1 comprises, as shown in FIG. 19, a controller 31, a main storage 32, an external storage 33, an operator 34, a display 35, an inputter/outputter 36, and a transmitter/receiver 37. The main storage 32, external storage 33, operator 34, display 35, inputter/outputter 36, and transmitter/receiver 37 are all connected to the controller 31 via an internal bus 30.

The controller 31 comprises a CPU (central processing unit) or the like, and executes the procedures of the candidates designator 13 and selection criteria adjuster 16 of the service content proposal device 1 according to control programs 39 stored in the external storage 33.

The main storage 32 comprises a RAM (random access memory) or the like, and with the control programs 39 stored in the external storage 33 being loaded, is used as the work area of the controller 31.

The external storage 33 comprises a nonvolatile memory such as a flash memory, hard disc, DVD-RAM (digital versatile disc random access memory), and DVD-RW (digital versatile disc rewritable), and pre-stores programs for the controller 31 to execute the processing of the service content proposal device 1. Furthermore, the external storage 33 supplies data stored by the programs to the controller 31 and stores data supplied from the controller 31 according to instruction by the controller 31. The storage 12 is configured in the external storage 33.

The operator 34 comprises a keyboard, a pointing device such as a mouse, and the like, and an interface device connecting the keyboard, pointing device, and the like to the internal bus 30. In the case of the provider directly entering information into the service content proposal device 1, the entered information is supplied to the controller 31 via the operator 34. When the provider 7 in FIG. 1 is included in the service content proposal device 1, the operator 34 may serve as the selector 71 and inputter.

The display 35 comprises a CRT (cathode ray tube), LCD (liquid crystal display), or the like, and in the case of the provider directly entering information into the service content proposal device 1, displays operation images on the screen. When the provider terminal 7 in FIG. 1 is included in the service content proposal device 1, the display 35 may serve as the outputter 7

The inputter/outputter 36 comprises a serial interface or parallel interface. In the case of the provider terminal 7 being an auxiliary device, the inputter/outputter 36 is connected to the provider terminal 7.

The transmitter/receiver 37 comprises a network terminal device or wireless communication device connected to a network and a serial interface or LAN (local area network) interface connected thereto. The transmitter/receiver 37 is connected to the user terminal 6 and provider terminal 7 via a network. The transmitter/receiver 37 functions as the user information receiver 11, transmitter 14, and provider selection information receiver 15.

The processing of the user information receiver 11, candidates designator 13, transmitter 14, provider selection information receiver 15, and selection criteria adjuster 16 of the service content proposal device 1 shown in FIGS. 1 and 12 is executed as the control programs 39 executes the processing using the controller 31, main storage 32, external storage 33, operator 34, display 35, inputter/outputter 36, transmitter/receiver 37, and the like as resources.

Additionally, the above-described hardware configuration and flowcharts are given by way of example, and any changes and corrections can be made.

The core part executing the service content proposal procedure, which comprises the controller 31, main storage 32, external storage 33, operator 34, display 35, inputter/outputter 36, and transmitter/receiver 37, internal bus 30, and the like, can be realized by a conventional computer system instead of a desiccated system. For example, the service content proposal device 1 executing the above-described processing can be configured by storing and distributing the computer programs for executing the above-described operation on a computer-readable non-transitory recording medium (a flexible disc, CD-ROM, DVD-ROM, or the like) and installing the computer programs on a computer. Alternatively, the service content proposal device 1 can be configured by pre-storing the computer programs in a storage device of a server unit on a communication network such as the Internet and allowing a conventional computer system to download the computer programs.

Furthermore, when the functions of the service content proposal device 1 are realized by apportionment between an OS (operation system) and application programs or cooperation of an OS and application programs, only the application programs can be stored on a non-transitory recording medium or in a storage device.

Furthermore, the computer programs can be superimposed on carrier waves to distribute them via a communication network. For example, the computer programs can be posted on a bulletin board system (BBS) on a communication network to distribute them via the network. Then, the computer programs can be activated and executed in a manner similar to other application programs under the control of an OS so that the above-described processing is executed.

The above-described embodiments can partly or entirely, but not exclusively, be described as in the following Supplementary Notes.

(Supplementary Note 1)

A service content proposal system proposing to a provider candidates for a service the provider provides to a user, comprising a user device, a provider device, and a service content proposal device, wherein

the user device comprises:

an acquirer that acquires user information including information regarding a service selected by the user and information regarding the user's action of using the selected service,

the provider device comprises:

a selector that receives selection from the candidates, and

the service content proposal device comprises:

a user information receiver that receives the user information from the user device;

a candidates designator that designates the candidates of which the values of given parameters satisfy given conditions based on statistical data of the service including the user information and provider selection criteria and user selection criteria including the parameters, and creating proposal information presenting the designated candidates;

a transmitter that transmits the proposal information to the provider device;

a provider selection information receiver that receives from the provider device provider selection information presenting the service selected by the provider;

a provider selection criteria adjuster that adjusts the provider selection criteria based on the provider selection information and the values of the parameters; and

a user selection criteria adjuster that adjusts the user selection criteria based on the user information.

(Supplementary Note 2)

the service content proposal system according to Supplementary Note 1, wherein

the acquirer comprises detection means detecting information regarding a service selected by the user and information regarding the user's action of having used the selected service, and

the user information includes information regarding a service selected by the user and information regarding the user's action of having used the selected service.

(Supplementary Note 3)

The service content proposal system according to Supplementary Note 1 or 2, wherein

the acquirer comprises:

a first outputter that outputs presentation information received from the service content proposal device and presenting user service candidates to present to the user; and

a first selector that receives selection of the user service by the user based on the presentation information and input of information regarding the action of using the selected user service,

the user information includes user selection information including information regarding the user service selected by the user and information regarding the action of using the selected user service,

the candidates designator of the service content proposal device comprises a first candidates designator that designates the service candidates of which the values of given parameters satisfy given conditions based on the statistical data and each of the provider selection criteria and user selection criteria including the parameters, and creating presentation information presenting the designated user service candidates; and

designates the user service candidates based on the user selection information and creates proposal information presenting the designated provider service candidates,

the provider selection criteria adjuster adjusts the provider selection criteria based on the provider selection information and the values of the parameters, and

the user selection criteria adjuster adjusts the user selection criteria based on the user selection information and the values of the parameters.

(Supplementary Note 4)

A service content proposal device connected to a user device and a provider device and proposing to a provider candidates for a service the provider provides to a user, comprising:

a receiver that receives from the user device user information including information regarding a service selected by the user and information regarding the user's action of using the selected service;

a candidates designator that designates the service candidates of which the values of given parameters satisfy given conditions based on statistical data of the service including the user information and each of provider selection criteria and user selection criteria including the parameters, and creating proposal information presenting the designated service candidates;

a transmitter that transmits the proposal information to the provider device;

a provider selection information receiver that receives from the provider device provider selection information presenting the service selected by the provider;

a provider selection criteria adjuster that adjusts the provider selection criteria based on the provider selection information and the values of the parameters; and

a user selection criteria adjuster that adjusts the user selection criteria based on the user information.

(Supplementary Note 5)

The service content proposal device according to Supplementary Note 4, wherein

the user information includes action information including information regarding a service selected by the user and information regarding the user's action of having used the selected service.

(Supplementary Note 6)

The service content proposal device according to Supplementary Note 4 or 5, wherein

the candidates designator comprises:

first candidates designator that designates the service candidates of which the values of given parameters satisfy given conditions based on the statistical data and each of the provider selection criteria and user selection criteria, and creates presentation information presenting the designated user service candidates; and

a presentation information transmitter that transmits the presentation information to the user device; and wherein

the user information receiver receives the user information including user selection information including information regarding a user service selected by the user from among the user service candidates and information regarding the user's action of using the selected user service,

the candidates designator refines the user service candidates based on the user selection information, designates provider service candidates to propose to the provider, and creates proposal information presenting the designated provider service candidates,

the provider selection criteria adjuster adjusts the provider selection criteria based on the provider selection information and the values of the parameters of the provider service candidates presented by the proposal information, and

the user selection criteria adjuster adjusts the user selection criteria based on the user selection information and the values of the parameters of the user service candidates presented by the presentation information.

(Supplementary Note 7)

The service content proposal device according to any of Supplementary Notes 4 to 6, wherein

the provider selection criteria and user selection criteria are each expressed by the parameters, calculation formulae normalizing the values of the parameters, and evaluation coefficients weighting the parameters, and

the candidates designator designates the service candidates of which the selection criteria value, which is obtained from the values of the parameters normalized by the normalization formulae and multiplied by the evaluation coefficients, is higher than a given value based on the statistical data and each of the provider selection criteria and user selection criteria as service candidates to propose to the provider.

(Supplementary Note 8)

The service content proposal device according to any of Supplementary Notes 4 to 6, wherein

the provider selection criteria and user selection criteria are each expressed by a formula comprising variables presenting the normalized values of the parameters and a constant, and

the candidates designator presents the formulae of the provider selection criteria and user selection criteria in a space of which the number of dimensions is equal to the number of parameters based on the statistical data stored in the storage and the provider selection criteria and user selection criteria, obtains a range acceptable to the provider and a range acceptable to the user, and designates the service candidates present in the region contained in both the provider acceptable range and user acceptable range as service candidates to propose to the provider.

(Supplementary Note 9)

The service content proposal device according to any of Supplementary Notes 4 to 8, wherein

there are two or more of the providers,

the candidates designator designates the service candidates of which the values of the parameters satisfy given conditions based on the statistical data, provider selection criteria of each of the providers, and the user selection criteria, and creates proposal information presenting the designated service candidates,

the provider selection information receiver receives from the provider device provider selection information presenting the service candidate selected by each of the providers, and

the provider selection criteria adjuster adjusts the provider selection criteria of each of the two or more providers based on the provider selection information and the values of the parameters.

(Supplementary Note 10)

The service content proposal device according to any of Supplementary Notes 4 to 9, wherein

the users are divided into two or more user classes,

the candidates designator designates the service candidates of which the values of the parameters satisfy given conditions based on the statistical data, the provider selection criteria, and user selection criteria of each of the user classes as service candidates to propose to the provider, and creates proposal information presenting the designated service candidates,

the user selection information receiver receives from the user terminal the user information in each of the user classes, and

the user selection criteria adjuster adjusts the user selection criteria of each of the user classes based on the user information.

(Supplementary Note 11)

The service content proposal device according to any of Supplementary Notes 4 to 10, comprising:

a storage that stores the statistical data, wherein

the storage stores conditions information including conditions enabling two or more of the services to be provided concurrently and settings for services to be linked, and

the candidates designator determines whether the service candidates are executable based on the conditions information and if not executable, excludes the service candidates from the service candidates to proposer to the provider.

(Supplementary Note 12)

A service content proposal method, comprising:

a user information acquisition step of acquiring user information including information regarding a service selected by a user and information regarding the user's action of using the selected service,

a user information reception step of receiving the user information from a user device;

a candidates designation step of designating the service candidates of which the values of given parameters satisfy given conditions based on statistical data of the service including the user information and each of provider selection criteria and user selection criteria including the parameters, and creating proposal information presenting the designated service candidates;

a transmission step of transmitting the proposal information to a provider device;

an output step of outputting the proposal information;

a selection step of receiving selection of the service by the provider based on the proposal information;

a provider selection information reception step of receiving from the provider device provider selection information presenting the service candidate selected by the provider;

a provider selection criteria adjustment step of adjusting the provider selection criteria based on the provider selection information and the values of the parameters; and

a user selection criteria adjustment step of adjusting the user selection criteria based on the user information.

(Supplementary Note 13)

The service content proposal method according to Supplementary Note 12, wherein

the user information acquisition step executed by the user terminal includes a detection step of detecting a service selected by the user and the action of having used the selected service, and

the user information includes action information presenting a service selected by the user and the action of having used the selected service,

(Supplementary Note 14)

The service content proposal method according to Supplementary Note 12 or 13, wherein

the user information acquisition step executed by the user terminal includes:

a first output step of outputting presentation information received from the service content proposal device and presenting user service candidates to present to the user; and

a first selection step of receiving selection of the user service by the user based on the presentation information and input of the action of using the selected user service,

the user information includes user selection information presenting information regarding the user service selected by the user and information regarding the user's action of using the selected user service,

the candidates designation step includes:

a first candidates designation step of designating the service candidates of which the values of given parameters satisfy given conditions based on the statistical data stored in the storage and the provider selection criteria and user selection criteria including the parameters as user service candidates to present to the user, and creating presentation information presenting the designated user service candidates; and

a presentation information transmission step of transmitting the presentation information to the user terminal,

the user service candidates are refined based on the user selection information and designated as provider service candidates to propose to the provider, and proposal information presenting the designated provider service candidates is created,

in the provider selection criteria adjustment step, the provider selection criteria are adjusted based on the provider selection information and the values of the parameters of the provider service candidates presented by the proposal information, and

in the user selection criteria adjustment step, the user selection criteria are adjusted based on the user selection information and the values of the parameters of the user service candidates presented by the presentation information,

(Supplementary Note 15)

The service content proposal method according to a of Supplementary Notes 12 to 14, wherein

the provider selection criteria and user selection criteria are expressed by the parameters, calculation formulae normalizing the values of the parameters, and evaluation coefficients weighting the parameters, and

in the candidates designation step, the service candidates of which the selection criteria value, which is obtained from the values of the parameters normalized by the normalization formulae and multiplied by the evaluation coefficients, is higher than a given value based on the statistical data stored in the storage and the provider selection criteria and user selection criteria are designated as service candidates to propose to the provider.

(Supplementary Note (6)

The service content proposal method according to any of Supplementary Notes 12 to 15, wherein

the provider selection criteria and user selection criteria are expressed by a formula comprising variables presenting the normalized values of the parameters and a constant, and

in the candidates designation step, the formulae of the provider selection criteria and user selection criteria are presented in a space of which the number of dimensions is equal to the number of parameters based on the statistical data stored in the storage and the provider selection criteria and user selection criteria, a range acceptable to the provider and a range acceptable to the user are obtained, and the service candidates present in the region contained in both the provider acceptable range and user acceptable range are designated as service candidates to propose to the provider.

(Supplementary Note 17)

The service content proposal method according to any of Supplementary Notes 12 to 16, wherein

there are two or more of the providers,

in the candidates designation step, the service candidates of which the values of the parameters satisfy given conditions are designated as service candidates to propose to each of the providers based on the statistical data, provider selection criteria of each of the providers, and the user selection criteria, and proposal information presenting the designated service candidates is created,

in the provider selection information reception step, provider selection information presenting the service candidate selected by each of the providers is received from the provider device, and

in the provider selection criteria adjustment step, the provider selection criteria of each of the two or more providers are adjusted based on the provider selection information and the values of the parameters of the service candidates presented by the proposal information.

(Supplementary Note 18)

The service content proposal method according to any of Supplementary Notes 12 to 17, wherein

the users are divided into two or more user classes,

in the candidates designation step, the service candidates of which the values of the parameters satisfy given conditions are designated as service candidates to propose to the provider based on the statistical data, the provider selection criteria, and user selection criteria, of each of the user classes, and proposal information presenting the designated service candidates is created,

in the user information reception step, the user information in each of the user classes is received from the user terminal, and

in the user selection criteria adjustment step, the user selection criteria of each of the user classes are adjusted based on the user information.

(Supplementary Note 19)

The service content proposal method according to any of Supplementary Notes 12 to 18, wherein

the storage means stores conditions information including conditions enabling two or more of the services to be provided concurrently and settings for services to be linked, and

in the candidates designation step, it is determined whether the service candidates are executable based on the conditions information and if not executable, the service candidates are excluded from the service candidates to proposer to the provider.

(Supplementary Note 20)

A computer-readable non-transitory recording medium on which programs are recorded that allow a computer to function as:

a user information receiver that receives from a user device user information including information regarding a service selected by the user and information regarding the user's action of using the selected service;

a candidates designator that designates the service candidates of which the values of given parameters satisfy given conditions based on statistical data of the service including the user information and each of provider selection criteria and user selection criteria including the parameters, and creating proposal information presenting the designated service candidates;

a provider selection information receiver that receives from a provider device provider selection information presenting the service selected by the provider;

a provider selection criteria adjuster that adjusts the provider selection criteria based on the provider selection information and the values of the parameters; and

a user selection criteria adjuster that adjusts the user selection criteria based on the user information,

The above-described embodiments are given by way of examples of specific embodiments of ate present disclosure and do not confine the technical scope of the present disclosure. The present disclosure can be implemented with any modification, application, or improvement within the scope of technical idea set forth in the scope of claims.

The present disclosure is based on Japanese Patent Application No. 2012-076901, filed on Mar. 29, 2012, and the entire specification, scope of claims, and drawings of which are incorporated herein by reference.

1. (canceled)

2. A service content proposal device connected to a user device and a provider device and proposing to a provider candidates for a service the provider provides to a user, comprising:
a receiver that receives from the user device user information including information regarding a service selected by the user and information regarding the user's action of using the selected service;
a candidates designator that designates the service candidates of which the values of given parameters satisfy given conditions based on statistical data of the service including the user information and each of provider selection criteria and user selection criteria including the parameters, and creating proposal information presenting the designated service candidates;
a transmitter that transmits the proposal information to the provider device;
a provider selection information receiver that receives from the provider device provider selection information presenting the service selected by the provider;
a provider selection criteria adjuster that adjusts the provider selection Criteria based on the provider selection information and the values of the parameters; and
a user selection criteria adjuster that adjusts the User rejection criteria based on the user information.

3. The service, content proposal device according to claim 2, wherein the user information includes action information including information regarding a service selected by the user and information regarding the user's action of having used the selected service.

4. The service content proposal device according to claim 2, wherein the candidates designator comprises:
a first candidates designator that designates the service candidates of which the values of given parameters satisfy given condition based on the statistical data and each of the provider selection criteria and user selection criteria, and creating presentation information presenting the designated user service candidates; and
a presentation information transmitter that transmits the presentation information to the user device,
the user information receiver receives the user information including user selection information including information regarding a user service selected by the user from among the use service candidates and information regarding the user's action of using the selected user service,
the candidates designator refines the user service candidates based on the user selection information, designates provider service candidates to propose to the provider, and creates proposal information presenting the designated provider service candidates,
the provider selection criteria adjuster adjusts the provider selection criteria based on the provider selection information and the values of the parameters of the provider service candidates presented by the proposal information, and
the user selection criteria adjuster adjusts the user selection criteria based on the user selection information and the values of the parameters of the user service candidates presented by the presentation information.

5. The service content proposal device according to claim 2, wherein
the provider selection criteria and user selection criteria are each expressed by the parameters, calculation formulae normalizing the values of the parameters, and evaluation coefficients weighting the parameters, and
the candidates designator designates the service candidates of which the selection criteria value, which is obtained from the values of the parameters normalized by the normalization formulae and multiplied by the evaluation coefficients, is higher than a given Value based on the statistical data and each of the provider selection criteria and user selection criteria as service, candidates to propose to the provider.

6. The service content proposal device according to claim 2, wherein
the provider selection criteria and user selection criteria are each expressed by a formula comprising variables presenting the normalized values of the parameters and a constant, and
the candidates designator presents the formulae of the provider selection criteria and user selection criteria in a space of which the number of dimensions is equal to the number of parameters based on the statistical data and each of the provider selection criteria and user selection criteria, obtains a range acceptable to the provider and a range acceptable to the user, and designates the service candidates present in the region contained in both the provider acceptable range and user acceptable range as service candidates to propose to the provider.

7. The service content proposal device according to claim 2, wherein there are two or more of the providers,
the candidates designator designates the service candidates of which the values of the parameters satisfy given conditions based on the statistical data, provider selection criteria of each of the providers, and the user selection criteria, and creates proposal information presenting the designated service candidates,
the provider selection information receiver receives from the provider device provider selection information presenting the service candidate selected by each of the providers, and
the provider selection criteria adjuster adjusts the provider selection criteria of each of the two or more providers based on the provider selection information and the values of the parameters.

8. The service content proposal device according to claim 2, comprising:
a storage that stores the statistical data, wherein
the storage, stores conditions information including conditions in which two or more of the services are providable concurrently and conditions which include settings for services linked each other, and
the candidates designator determines whether the service candidates are executable or not based on the conditions information, and if the service candidates are not executable, excludes the service candidates from the service candidates to proposer to the provider.

9. A service content proposal method, comprising:
an acquisition step of acquiring user information including information regarding a service selected by a user and information regarding the user's action of using the selected service,
a user information reception step of receiving the user information from a user device;
a candidates designation step of designating the service candidates of which the values of given parameters satisfy given conditions based on statistical data of the service including the user information and each of provider selection criteria and user selection criteria including the parameters, and creating proposal information presenting the designated service candidates;
a transmission step of transmitting the proposal information to a provider device;
an output step of outputting the proposal information;
a selection step of receiving selection of the service by the provider based on the proposal information;
a provider selection information reception step of receiving from the provider device provider selection information presenting the service candidate selected by the provider;
a provider selection criteria adjustment step of adjusting the provider selection criteria based on the provider selection information and the values of the parameters; and
a user selection criteria adjustment step of adjusting the user selection criteria based on the user information.

10. A computer-readable non-transitory recording medium in which a program is recorded that allow a computer to function as:
a user information receiver that receives from a user device user information including information regarding a service selected by the user and information regarding the user's action of using the selected service;
a candidates designator that designates the service candidates of which the values of given parameters satisfy given conditions based on statistical data of the service including the user information and each of provider selection criteria and user selection criteria including the parameters, and creating proposal information presenting the designated service candidates;
a provider selection information receiver that receives from a provider device provider selection information presenting the service selected by the provider;
a provider selection criteria adjuster that adjusts the provider selection criteria based on the provider selection information and the values of the parameters; and
a user selection criteria adjuster that adjusts the user selection criteria based on the user information.

11. The service, content proposal device, according to claim 2, wherein the users are divided into two or more user classes,
the candidates designator designates the service candidates of which the values of the parameters satisfy given conditions based on the statistical data, the provider selection criteria, and user selection criteria of each of the user classes as service candidates to propose to the provider, and creates proposal information presenting the designated service candidates,
the user selection information receiver receives from the user terminal the user information in each of the user classes, and
the user selection criteria adjuster adjusts the user selection criteria of each of the user classes based on the user information.

12. The service content proposal device according to claim 3, wherein the candidates designator comprises:
a first candidates designator that designates the service candidates of which the values of given parameters Satisfy given condition based on the statistical data and each of the provider selection criteria and user selection criteria, and creating presentation information presenting the designated user service, candidates; and
a presentation information transmitter that transmits the presentation information to the user device,
the user information receiver receives the user information including user selection information including information regarding a user service selected by the user from among the user service candidates and information regarding the user's action of using the selected user service,
the candidates designator refines the user service candidates based on the user selection information, designates provider service candidates to propose to the provider, and creates proposal information presenting the designated provider service candidates,
the provider selection criteria adjuster adjusts the provider selection criteria based on the provider selection information and the values of the parameters of the provider service candidates presented by the proposal information, and
the user selection criteria adjuster adjusts the user selection criteria based on the user selection information and the values of the parameters of the user service candidates presented by the presentation information.

13. The service content proposal device according to claim 3, wherein
the provider selection criteria and user selection criteria are each expressed by the parameters, calculation formulae normalizing the values of the parameters, and evaluation coefficients weighting the parameters, and
the candidates designator designates the service candidates of which the selection criteria value, which is obtained from the values of the parameters normalized by the normalization formulae and multiplied by the evaluation coefficients, is higher than a given value based on the statistical data and each of the provider selection criteria and user selection criteria as service candidates to propose to the provider.

14. The service content proposal device according to claim 4, wherein
the provider selection criteria and user selection criteria are each expressed by the parameters, calculation formulae normalizing the values of the parameters, and evaluation coefficients weighting the parameters, and
the candidates designator designates the service candidates of which the selection criteria value, which is obtained from the values of the parameters normalized by the normalization formulae and multiplied by the evaluation coefficients, is higher than a given value based on the statistical data and each of the provider selection criteria and user selection criteria as service candidates to propose to the provider.

15. The service content proposal device according to claim 3, wherein
the provider selection criteria and user selection criteria are each expressed by a formula comprising variables presenting the normalized values of the parameters and a constant, and
the candidates designator presents the formulae of the provider selection criteria and user selection criteria in a space of which the number of dimensions is equal to the number of parameters based on the statistical data and each of the provider selection criteria and user selection criteria, obtains a range acceptable to the provider and a range acceptable to the user, and designates the service candidates present in the region contained in both the provider acceptable range and user acceptable range as service candidates to propose to the provider.

16. The service content proposal device according to claim 4, wherein
the provider selection criteria and user selection criteria are each expressed by a formula comprising variables presenting the normalized values of the parameters and a constant, and
the candidates designator presents the formulae of the provider selection criteria and user selection criteria in a space of which the number of dimensions is equal to the number of parameters based on the statistical data and each of the provider selection criteria and user selection criteria, obtains a range acceptable to the provider and a range acceptable to the user, and designates the service candidates present in the region contained in both the provider acceptable range and user acceptable range service candidates to propose to the provider.

17. The service content proposal device according to claim 3, wherein there are two or more of the providers,
the candidates designator designates the service candidates of which the values of the parameters satisfy given conditions based on the statistical data, provider selection criteria of each of the providers, and the user selection criteria, and creates proposal information presenting the designated service candidates,
the provider selection information receiver receives from the provider device provider selection information presenting the service candidate selected by each of the providers, and
the provider selection criteria adjuster adjusts the Provider selection criteria of each of the two or more providers based on the provider selection information and the values of the parameters.

18. The service content proposal device according to claim 4, wherein there are two or more of the providers,
the candidates designator designates the service candidates of which the values of the parameters satisfy given conditions based on the statistical data, provider selection criteria of each of the providers, and the user selection criteria, and creates proposal information presenting the designated service candidates,
the provider selection information receiver receives from the provider device provider selection information presenting the service, candidate selected by each of the providers, and
the provider selection criteria adjuster adjusts the provider selection criteria of each of the two or more providers based on the provider selection information and the values of the parameters.

19. The service content proposal device according to claim 5, wherein there are two or more of the providers,
the candidates designator designates the service candidates of which the values of the parameters satisfy given conditions based on the statistical data, provider selection criteria of each of the providers, and the user selection criteria, and creates proposal information presenting the designated service candidates,
the provider selection information receiver receives from the provider device provider selection information presenting the service candidate selected by each of the providers, and
the provider selection criteria adjuster adjusts the provider selection criteria of each of the two or more providers based on the provider selection information and the values of the parameters.

20. The service content proposal device according to claim 6, wherein there are two or more of the providers,
the candidates designator designates the service candidates of which the values of the parameters satisfy given conditions based on the statistical data, provider selection criteria of each of the providers, and the user selection criteria, and creates proposal information presenting the designated service candidates,
the provider selection information receiver receives from the provider device provider selection information present mg the service candidate selected by each of the providers, and
the provider selection criteria adjuster adjusts the provider selection criteria of each of the two or more providers based on the provider selection information and the values of the parameters.
